(19) United States
(12) Patent Application Publication
(10) Pub. No.: US 2005/0145301 A1
(43) Pub. Date: Jul. 7, 2005

(54) Composite rare earth anisotropic bonded magnet, compound for composite rare earth anisotropic bonded magnet, and method for production thereof

(75) Inventor: Yoshinobu Honkura, Aichi-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AICHI STEEL CORPORATION, AICHI (JP)

(21) Appl. No.: 10/509,687

(22) PCT Filed: Apr. 9, 2003
(86) PCT No.: PCT/JP03/04532

(30) Foreign Application Priority Data
Apr. 9, 2002 (WO) PCT/JP02/03541

(51) Int. Cl. H01F 1/08

(52) U.S. Cl. 148/105; 148/302

(57) ABSTRACT

The bonded magnet of the present invention, in which average particle diameter and compounding ratio are specified, is comprised of R1FeB coarse powder that has been surface coated with surfactant, R2Fe(N, B) fine powder that has been surface coated with surfactant (R1 and R2 are rare-earth elements), and a resin which is a binder. Because the outside of R1FeB coarse powder is enveloped by resin in which R2Fe(N, B) fine powder is evenly dispersed, the R2Fe(N, B) fine powder and resin become a cushion and the R1FeB coarse powder does not deteriorate. As a result, the R1FeB coarse powder exhibits intrinsically excellent magnetic properties, and a bonded magnet with excellent magnetic properties and permanent flux loss ratio is obtained.

### TECHNICAL FIELD

The present invention relates to a composite rare-earth anisotropic bonded magnet having both excellent magnetic properties and extremely low aging loss, a compound employed in that magnet, and methods for their production.

### BACKGROUND ART

Hard magnets (permanent magnets) are used in various types of equipment, such as motors. Even within this field, there is a strong demand for compact, high-output motors for use in automobiles. From the viewpoint of having high performance magnetic properties but also ensuring motor reliability, low aging loss is sought for these hard magnets.

From the viewpoint of high magnetic properties, the development of RFeB rare-earth magnets, comprised of a rare-earth element (R), boron (B), and iron (Fe), is being actively carried out at present. For example, RFeB magnet alloys (composition) having magnetic isotropy are disclosed in U.S. Pat. No. 4,851,058 (below, “conventional technology 1”) and U.S. Pat. No. 5,411,608 (below, “conventional technology 2”) as this type of RFeB rare-earth magnet.

However, these rare-earth magnets easily deteriorate, due to the oxidation of the rare earth element and Fe which are their main ingredients, and it is difficult to ensure those high magnetic properties with stability. In particular, when using rare-earth magnets above room temperature, there is a tendency for those magnetic properties to decrease dramatically. Ordinarily, aging loss is quantitatively indicated by the permanent flux loss ratio (%), but in the case of conventional rare-earth anisotropic magnets, this permanent flux loss ratio nearly always exceeded 10%. Permanent flux loss ratio is the percentage decrease in magnetic flux which can not be recovered even after remagnetizing, following the passage of a long period of time (more than 1000 hours) at high temperature(100° C. or 120° C).

Recently, a rare-earth bonded magnet (below, simply “bonded magnet”) made by press molding a mixture of two types of rare-earth magnet powder having large grain diameter and small grain diameter (below, simply “magnet powder”) and a resin as binder is being proposed. In this case, the small diameter magnet powder enters into the gaps formed by the large diameter magnet powder, and as a whole filling factor (relative density) improves. By increasing the density of the magnet, magnetic properties of course improve, intrusion of oxygen and moisture into the magnet is controlled, and the heat resistance and corrosion resistance of the magnet improve. Disclosures regarding this sort of bonded magnet are made in the official publications as given below.
(1) Japanese Patent Application Laid-Open (Kokai) No. 5-152116 (below, “Publication 1”)

In this publication, a bonded magnet is disclosed in which an epoxy binder resin is added to a mixture of magnet powder combining, in a wide variety of ratios, magnet powder made from an Nd₂Fe₁₄B alloy and having a grain diameter of 500 μm or less (below, “NdFeB magnet powder”), and magnet powder made from an Sm₂Fe₁₇N alloy and having a grain diameter of 5 μm or less (below, “SmFeN powder”). The mixture is compression molded, and the resin is then heat-hardened.

In this case, the grain diameters of the powders to be mixed were respectively determined after carefully considering the single domain particle coercive force structure originally held by the Sm₂Fe₁₇N alloy, and the fact that magnetic properties deteriorate when the Nd₂Fe₁₄B alloy is simply fine ground. Due to SmFeN alloy powder filling the gaps formed between grains of coarse NdFeB alloy powder, the filling factor of the whole is improved, obtaining a bonded magnet with high magnetic properties (maximum energy product (BH)max: 128 kJ/m³).
(2) Japanese Patent Application Laid-Open (Kokai) No. 6-132107 (below, “Publication 2”)

In this publication as well, just as in above-mentioned Publication 1, a bonded magnet is disclosed in which NdFeB alloy powder, SmFeN alloy powder, and binder resin are mixed and then compression molded. However, it does not surpass the level of Publication 1.

In this publication, despite making disclosures with respect to the grain diameter and mixing ratio of each magnet powder, nothing is concretely disclosed concerning the magnetic properties or production method of the magnet powder, which exert a large influence on the magnetic properties of the bonded magnet.
(3) Japanese Patent Application Laid-Open (Kokai) No. 9-92515 (below, “Publication 3”)

In this publication, a bonded magnet is disclosed in which (1) anisotropic magnet powder comprised of Nd₂Fe₁₄B with an average grain diameter of 150 μm, (2) ferrite magnet powder comprised of SrO.6Fe₂O₃ with a mixing ratio of 0 to 50 wt % and an average grain diameter of 0.5 to 10.7 μm, and (3) 3 wt % of epoxy resin which is a binder are mixed, vacuum dehydrated, compression molded, and heat hardened, thereby obtaining the disclosed bonded magnet. This bonded magnet shows high magnetic properties of 132 to 150.14 kJ/m³, and excellent heat resistance and corrosion resistance, with permanent flux loss ratio −3.5 to −5.6%. However, magnetic properties were still inadequate. The permanent flux loss ratio stated in this publication is after 1000 hours at 100° C. Also, in order to prevent deterioration of magnetic properties due to machine crushing, the above-mentioned NdFeB alloy powder was obtained by crushing ingots which employed an HDDR process (hydrogenation treatment process), and the powder was comprised of an aggregate structure of re-crystallized grains comprised of Nd₂Fe₁₄B tetragonal phase.

In this publication, the advantages of making a bonded magnet by mixing two types of magnet powder with different grain diameters are explained as follows. When molding a bonded magnet, the result of having ferrite magnet powder preferentially fill the grain gaps of anisotropic NdFeB alloy powder (or the grain gaps of that powder thinly coated by binder resin) is that the air gap percentage will decrease.

In this way, (1) intrusion of O₂ and H₂O into the bonded magnet is controlled, improving heat resistance and corrosion resistance; (2) parts that were air gaps are permutated by ferrite magnet powder, improving magnetic properties; further, (3) as a result of the ferrite magnet powder mitigating the stress concentration on the NdFeB alloy powder generated when molding the bonded magnet, fracturing of the NdFeB alloy powder is controlled. Thereby, exposure of exceptionally active fractured metal surfaces in the bonded magnet is controlled, and the heat resistance and corrosion resistance of the bonded magnet are further improved. Additionally, (4) by mitigating the stress concentration with ferrite magnet powder, the introduction of deformations into the magnet powder is controlled, further improving magnetic properties.
(4) Japanese Patent Application Laid-Open (Kokai) No. 9-115711 (below, “Publication 4”)

In this publication, a bonded magnet is disclosed which uses, in place of the ferrite magnet powder of above-mentioned Publication 3, isotropic nano-composite magnet powder with an average grain diameter of 3.8 μm, comprised of (1) soft magnetic phase including body-centered cubic iron with average crystalline grain diameter 50 nm or less and iron boride, and (2) hard magnetic phase having Nd₂Fe₁₄B-form crystal. Despite having high magnetic properties of 136.8 to 150.4 kJ/m³, and excellent heat resistance and corrosion resistance with an permanent flux loss ratio of −4.9 to −6.0%, magnetic properties were still inadequate. The measurement method for this permanent flux loss ratio and the production process for anisotropic NdFeB magnet powder are the same as in the case of Publication 3.

Publication 4 also discloses, as a comparison example, a bonded magnet produced by mixing NdFeB magnet powder and SmFeN magnet powder with a smaller grain diameter than that of the NdFeB powder. Despite having excellent initial magnet properties ((BH)max: 146.4 to 152.8 kJ/m³), it is disclosed that that bonded magnet has inferior corrosion resistance (permanent flux loss ratio: −13.7 to −13.1%), caused by the inferiority of SmFeN magnet powder (vulnerable to oxidation)

Thus, the points disclosed with respect to magnetic properties and inferior corrosion resistance differ in some respects from Publication 1 and Publication 2.
(5) Japanese Patent Application Laid-Open (Kokai) No. 10-289814 (below, “Publication 5”)

In this publication, a bonded magnet is disclosed in which the filling factor and orientation of the magnet powder are improved. Specifically, a bonded magnet is disclosed which is formed by combining magnet powder which is structured so that one grain is about one crystal grain (coarse magnet powder) and magnet powder comprised of grains with a much smaller grain diameter (fine magnet powder), then performing compression molding and curing heat treatment.

Both of the magnet powders used therein are obtained by further sorting mechanically crushed identical Sm—Co—Fe—Cu—Zr alloys. The powders are manufactured so that making average crystal grain diameter D and powder grain diameter d, the coarse magnet powder satisfies 0.5 D≦d≦1.5 D, and the fine magnet powder satisfies 0.01 D≦d≦0.1 D.

Incidentally, the magnet powder obtained by HDDR treatment, due to its structural transformation, has an average crystal grain diameter of about 0.3 μm, and the grain diameter of magnet powder grains is about 200 μm. Therefore, bonded magnets employing magnet powder obtained via HDDR treatment will naturally differ from bonded magnets of the type mentioned above.

As stated above, various processes have been proposed to mix magnet powders of differing grain diameters and produce a bonded magnet, improving the magnetic properties and corrosion resistance of the bonded magnet. However, the characteristics of those magnets are still inadequate. In particular, in the case of bonded magnets which mix coarse magnet powder such as NdFeB magnet powder and fine magnet powder such as SmFeN magnet powder, even those as in above-mentioned Publication 4, the corrosion resistance was inferior despite having excellent initial magnetic properties.

The present invention is made in light of that situation. I.e., a goal of the present invention is to furnish a bonded magnet which provides high magnetic properties and high corrosion resistance not available in conventional technology. The present invention also aims to provide a compound suitable for manufacture of that bonded magnet and production methods for that compound and bonded magnet.

### DISCLOSURE OF INVENTION

The inventor of the present invention diligently researched a way to solve the above-mentioned problem, and as a result of accumulated systematic experimentation, and overturning conventional wisdom, newly discovered that a bonded magnet was obtained with not only excellent initial magnet properties, but also excellent corrosion resistance, even when using coarse NdFeB magnet powder and fine SmFeN magnet powder. And, based on this discovery, the inventor realized that generally the same result was obtained with respect to R1FeB coarse powder comprised of that NdFeB magnet powder or the like and R2Fe(N, B) fine powder comprised of that SmFeN magnet powder or the like, and completed the present invention.

(Composite Rare-Earth Anisotropic Bonded Magnet)

The composite rare-earth anisotropic bonded magnet of the present invention is a bonded magnet comprising:
(A) 50 to 84 mass % of R1FeB coarse powder, comprising:
1. R1FeB anisotropic magnet powder with an average grain diameter of 50 to 400 μm, obtained by performing a hydrogenation treatment on an R1FeB alloy having a rare earth element including yttrium (Y) (hereafter, “R1”), iron (Fe), and boron (B) as its main ingredients; and
2. #1 surfactant that coats the surface of the constituent grains of the said R1FeB anisotropic magnet powder; and
(B) 15 to 40 mass % of R2Fe(N, B) fine powder, comprising:
1. R2Fe (N, B) anisotropic magnet powder with an average grain diameter of 1 to 10 μm, having a rare-earth element including Y (hereafter, “R2”), Fe, and nitrogen (N) or B as its main ingredients; and
2. #2 surfactant that coats the surface of the constituent grains of the said R2Fe (N, B) anisotropic magnet powder; and
(C) 1 to 10 mass % of a resin as binder.

This bonded magnet has the special features that maximum energy product (BH)max is 167 to 223 kJ/m³, and permanent flux loss ratio, which indicates the proportion of magnetic flux loss which can be obtained with remagnetizing after the passage of 1000 hours at 100° C., is 6% or less.

Thus a composite rare-earth anisotropic bonded magnet (below, “bonded magnet”) was obtained which shows excellent magnetic properties not available in the conventional technology, along with extremely limiting aging loss. To give specific examples, this bonded magnet shows outstanding heat resistance and corrosion resistance, with permanent flux loss ratios, which indicate the proportion of magnetic flux loss which can be obtained with remagnetizing after the passage of 1000 hours at 100° C., of 6% or less, 5% or less, or 4.5% or less. Also, for maximum energy product (BH)max, for example, it shows high magnetic properties of 167 kJ/m³ or more, 180 kJ/m³or more, 190 kJ/m³ or more, 200 kJ/m³ or more, or even 210 kJ/m³ or more. Further, in order to obtain these sorts of high magnetic properties, it is desirable for the (BH)max of R1FeB coarse powder to be 279.3 J/m³ or more, and for the (BH)max of R2Fe(N, B) fine powder to be 303.2 kJ/m³ or more.

This sort of bonded magnet of the present invention is compatible with a high order of both magnetic properties and corrosion resistance not available in the conventional technology. However, in response to the uses of bonded magnets, it is possible to further increase just one of these two properties. For example, for bonded magnets used in a high temperature environment, there are times when corrosion resistance is prioritized over magnetic properties. In such an instance, for example, it is desirable to make corrosion resistance excellent with a permanent flux loss ratio of −4% or less (for example, −3.3%), while slightly lowering magnetic properties to a (BH)max of 160 to 165 kJ/m³ (for example, 164 kJ/m³). Also, as a way of designing for lower cost by abbreviating the homogenization heat treatment, large amounts of B may be included even from conventional RFeB anisotropic magnet powder, or La may be included to further improve corrosion resistance. In this sort of bonded magnet, it is desirable to make corrosion resistance excellent with a permanent flux loss ratio of −4% or less (for example, −3.4%), while slightly lowering magnetic properties to a (BH) max of 140 to 160 kJ/m³. Further, in the case of designing for lower cost of the bonded magnet by lowering the mixture amount of R1FeB coarse powder, if excellent corrosion resistance with a permanent flux loss ratio of −5% or less (for example, −4.5%) can be insured even for magnetic properties of (BH)max 130 to 140 kJ/m³, this may be adequate in actual use. And, as is clear from the example embodiments which will be mentioned later, the inventor of the present invention has actually obtained this sort of bonded magnet.

At present, the reason it was possible to obtain a bonded magnet with not only initial magnetic properties but also extremely small aging loss, and that mechanism, may be thought of as follows. R2FeN anisotropic magnet powder such as SmFeN magnet powder and R2FeB anisotropic magnet powder such as NdFeB magnet powder are included in the R2Fe (N, B) anisotropic magnet powder of the present specification. Therefore, it is sufficient for the R2Fe (N, B) anisotropic powder to be composed of at least one of those. Below, as one example of R2Fe(N, B) anisotropic magnet powder, the case of using R2FeN anisotropic magnet powder (particularly, SmFeN magnet powder) is explained, but this is not meant to exclude R2FeB anisotropic magnet powder such as NdFeB magnet powder. These matters are the same with respect to R2Fe(N, B) fine powder.

As also recited in above-mentioned Publication 4, the primary cause of aging loss in composite rare-earth bonded magnets comprised of R1FeB magnet powder such as NdFeB magnet powder and R2Fe (N, B) magnet powder such as SmFeN magnet powder has up to now thought to be the ease of oxidation of R2Fe(N, B) powder comprised of powder such as SmFeN magnet powder. However, in the diligent research of the inventor of the present invention, in the case of bonded magnets comprised of R1FeB anisotropic magnet powder obtained by hydrogenation treatment (particularly, NdFeB magnet powder) and R2Fe (N, B) anisotropic magnet powder (particularly, SmFeN magnet powder), the primary cause of aging loss is thought rather to be found in fractures due to micro-cracks occurring in the R1FeB anisotropic magnet powder grains at the time of bonded magnet molding. This is because it is thought that when these micro-cracks occur, active fractured metal surfaces are exposed, oxidation of the R1FeB anisotropic magnet powder progresses, and aging loss of the bonded magnet occurs. In particular, because R1FeB anisotropic magnet powder obtained by hydrogenation treatment is highly susceptible to fractures due to micro-cracks, the above-mentioned aging loss readily occurs.

As in the above-stated Publications 1, 2, and 4, when combining and mixing hydrogenated R1FeB anisotropic magnet powder, R2Fe(N, B) magnet powder, and resin and molding the bonded magnet at normal temperature, mitigation of stress which occurs during that molding is inadequate, and it is not possible to prevent or control fractures due to micro-cracks occurring in the constituent grains of R1FeB anisotropic magnet powder. Further, in the case of molding at normal temperature, high density is difficult to obtain because fluidity of the resin is inadequate, making it impossible to design for improvement of magnetic properties. Due to inadequate exclusion of oxygen which is the main cause of oxidation, magnetic properties along with corrosion resistance are inadequate.

The inventor of the present invention hit on the idea of employing heat molding when molding the bonded magnet from the compounded magnet powder, creating a state in which each constituent grain of R1FeB anisotropic magnet powder is floating in a fluid layer formed during that heat molding (below, called the “ferromagnetic fluid layer” in the present specification), increasing the fluidity between the above-mentioned constituent grains, and so mitigating the stress that occurs between constituent grains. Also, the inventor had the idea of this sort of ferromagnetic fluid layer being composed of binder resin and fine R2Fe (N, B) anisotropic magnet powder dispersed in that resin. The inventor succeeded at obtaining a bonded magnet which furnishes excellent magnetic properties and corrosion resistance.

It should be noted here that in the bonded magnet of the present invention, it is not the case that magnet powders of differing grain diameters and binder resin are simply mixed and then molded, as in the conventional technology. In regard to the normal temperature molding of the conventional technology, the inventor of the present invention has confirmed that when simply employing heat molding, a state in which R1FeB anisotropic magnet powder is floating in a fluid layer will not necessarily be formed, and adequate fluidity between those constituent grains will not be obtained. It is necessary for the coarse R1FeB anisotropic magnet powder to be in a state in which it is floating in the fluid layer, and in order to increase the fluidity between each constituent grain, for the R1FeB anisotropic magnet powder and R2Fe(N, B) anisotropic magnet powder to fit snugly together in the binder resin, as in the present invention.

And so in the present invention, by coating the surface of each of the R1FeB anisotropic magnet powder and R2Fe(N, B) anisotropic magnet powder with surfactant that decreases the free energy of the surface against the resin, the above-stated problem was solved. Due to the intervention of this surfactant, within that resin, high fluidity is exhibited with the R1FeB anisotropic magnet powder and R2Fe(N, B) anisotropic magnet powder, unlike in the conventional technology. In other words, during heat molding of the bonded magnet, the R1FeB anisotropic magnet powder and R2Fe (N, B) anisotropic magnet powder are in a state as if completely floating in the above-stated fluid layer. From the viewpoint of the large grain diameter R1FeB anisotropic magnet powder, the small grain diameter R2Fe (N, B) anisotropic magnet powder in the resin is in a state as if floating in the high fluidity ferromagnetic fluid layer.

Doing so, as stated above, an effect is obtained of alleviating extraordinarily high pressure during formation of the bonded magnet, and it is thought that aging loss of magnetic properties which accompanies the generation of micro-cracks in the R1FeB anisotropic magnet powder is markedly reduced. Further, due to this excellent fluidity, it became possible to obtain a bonded magnet having adequate density and extraordinarily high magnetic properties. This means that the lubrication between each magnet powder improves, and extraordinarily excellent filling was obtained. This high filling factor is at a level not seen in the conventional technology, and due to this high filling factor, maximum energy product (BH)max, which is the main property of a magnet, can be made an extraordinarily excellent property not available in the conventional technology. When striving for higher density due to improvement of the filling factor which comes from conventional normal temperature molding, due to destroying R1FeB coarse powder, it was normal for corrosion resistance (permanent flux loss properties) to deteriorate even though (BH)max improved. I.e., when there was this kind of increase in density, it was difficult to manage both magnetic properties and corrosion resistance, and so the two properties had an opposing relationship.

By doing as in the present invention however, it is possible to attain high density while preventing destruction of R1FeB coarse powder, and further, an oxygen exclusion effect is added by decreasing air gaps due to high density, very excellent maximum energy product and permanent flux loss ratio are obtained, and it is possible to manage both magnetic properties and corrosion resistance at levels not available in the conventional technology.

The above-mentioned fluidity is effectively used when molding the bonded magnet within a magnetic field as well. That is, the fluidity of each anisotropic magnet powder is high, and consequently excellent orientation and filling factor are obtained. By managing both excellent orientation and filling factor, magnetic properties are even more improved.

In the present specification, for the sake of convenience, coarse R1FeB anisotropic magnet powder whose surface is coated with #1 surfactant is called “R1FeB coarse powder”, and fine R2Fe(N, B) anisotropic magnet powder whose surface is coated with #2 surfactant is called “R2Fe (N, B) fine powder”.

As stated above, the above-mentioned ferromagnetic fluid layer is comprised of binder resin and R2Fe(N, B) fine powder evenly dispersed in this resin. This is formed when the mixture (in the state of either powder or a molded body) comprised of R1FeB coarse powder, R2Fe(N, B) fine powder, and resin is heated and the bonded magnet is molded. Specifically, it is a layer in a fluid state that occurs above the softening point of that resin. Accordingly, this ferromagnetic fluid layer is generated in the region of the melting point or softening temperature of the resin. If this resin is in a range at which it does not react or change state, the temperature is high and a ferromagnetic fluid layer is obtained which naturally has high fluidity. This resin may be either thermoplastic or thermosetting resin.

When that resin is thermosetting resin, the resin may be heated above the hardening point for a short period of time. This is because immediately thermosetting resin will not start to harden due to bridging. Rather, by heating above the hardening temperature from the outset of heat molding, a ferromagnetic fluid layer with excellent fluidity is quickly formed. In particular, a bonded magnet with excellent corrosion resistance along with high density and excellent magnetic properties is obtained. Further, though it goes without saying, when heating to a temperature above the hardening point, thermosetting resin will begin to harden after progressing for the designated time, and the above-mentioned ferromagnetic fluid layer will become a hardened layer. Also, when that resin is thermoplastic resin, the ferromagnetic fluid layer will become a hardened layer due to subsequent cooling.

When manufacturing the below-stated compound using thermosetting resin, it is good for the temperature during heat kneading to be above the softening point and below the hardening point of that resin. This is because when using a compound manufactured by heat kneading at a temperature above the hardening point, fractures are generated in the obtained bonded magnet, and magnetic properties deteriorate.

As stated above, in a temperature region at which the resin softens, that ferromagnetic fluid layer has high fluidity, and the coarse grain diameter R1FeB anisotropic magnet powder is satisfactorily lubricated by that ferromagnetic fluid layer via the surfactant. The result is that an effect is obtained of alleviating extraordinarily high pressure during formation of the bonded magnet, the above-stated generation of micro-cracks and accompanying fractures can be prevented, and aging loss of magnetic properties which accompanies the oxidation of newly-created fracture surfaces is markedly reduced. Also, due to such excellent fluidity, a high degree of lubrication, orientation, and filling, and a high degree of oxygen exclusion which accompanies a high degree of filling were obtained, and a bonded magnet was obtained which furnishes both extraordinarily high magnetic properties and high corrosion resistance.

A bonded magnet having this sort of excellent corrosion resistance is extremely suitable not only for equipment used in room temperature environments, but also for equipment used in high temperature environments in which deterioration from oxidation easily progresses (for example, drive motors for electric and hybrid vehicles). In these applications, bonded magnets are sought which retain high magnetic properties with maximum energy product (BH)max of 167 kJ/m³ or greater, and excellent corrosion resistance with permanent flux loss ratio of 6% or less. The bonded magnet of the present invention is the first to satisfy these requirements.

(Composite Rare-Earth Anisotropic Bonded Magnet Compound)

The present invention can also be understood as a compound suitable for manufacturing the above-mentioned bonded magnet.

That is, the present invention may also be a composite rare-earth anisotropic bonded magnet compound comprising:
(A) 50 to 84 mass % of R1FeB coarse powder, comprising:
1. R1FeB anisotropic magnet powder with an average grain diameter of 50 to 400 μm, obtained by performing a hydrogenation treatment on an R1FeB alloy having R1, Fe, and B as its main ingredients; and
2. #1 surfactant that coats the surface of the constituent grains of the said R1FeB anisotropic magnet powder; and
(B) 15 to 40 mass % of R2Fe(N, B) fine powder, comprising:
1. R2Fe (N, B) anisotropic magnet powder with an average grain diameter of 1 to 10 μm, having R2, Fe, and N or B as its main ingredients; and
2. #2 surfactant that coats the surface of the constituent grains of the said R2Fe(N, B) anisotropic magnet powder; and
(C) 1 to 10 mass % of a resin as binder;
   this bonded magnet compound having the special feature that the surface of the constituent grains of the said R1FeB coarse powder is coated by a coating layer in which the said R2Fe(N, B) fine powder is evenly dispersed in the said resin.

With such excellent dispersion, i.e., due to the R2Fe(N, B) fine powder and resin being evenly dispersed around the R1FeB coarse powder, even if the molding pressure when molding the bonded magnet is comparatively low, it becomes possible to obtain a bonded magnet having sufficiently high density and high magnetic properties. This decrease in molding pressure contributes to decreased manufacturing cost, due to cutting equipment expenses and shortening manufacturing process time.

This is thought to be due to being able to shorten the distance the R2Fe(N, B) fine powder moves in the gaps between grains of R1FeB coarse powder, due to R2Fe(N, B) fine powder and resin being evenly dispersed around the R1FeB coarse powder.

In addition to such a working effect, due to R2Fe(N, B) fine powder and resin being evenly dispersed around the R1FeB coarse powder, uneven distribution during heat molding in a magnetic field is eliminated, and R2Fe (N, B) fine powder is both evenly and quickly supplied between the constituent grains of R1FeB coarse powder. Also, it is thought that a higher filling factor and an effect of high deterrence of fractures in the R1FeB coarse powder are easily attained under low pressure. Additionally, these working effects appear markedly in compounds in which R1FeB coarse powder, R2Fe (N, B) fine powder, and resin are heat kneaded in advance.

For this composite rare-earth anisotropic bonded magnet compound, it is suitable when, for example, relative density of the bonded magnet obtained when heat molding in a magnetic field under conditions of molding temperature 150° C., magnetic field 2.0 MA/m, and molding pressure 392 MPa is 92 to 99%.

(Production Method for Composite Rare-Earth Anisotropic Bonded Magnet and Compound)

Further, the present invention can also be understood as a production method for the above-stated bonded magnet and compound.

That is, the present invention may also be a composite rare-earth anisotropic bonded magnet production method comprising:
(1) A heat orientation process in which a mixture comprising:
   (A) 50 to 84 mass % of R1FeB coarse powder, comprising
      R1FeB anisotropic magnet powder with an average grain diameter of 50 to 400 μm, obtained by performing a hydrogenation treatment on an R1FeB alloy having R1, Fe, and B as its main ingredients, the surface of the constituent grains of R1FeB anisotropic magnet powder being coated with a #1 surfactant; and
   (B) 15 to 40 mass % of R2Fe(N, B) fine powder, comprising
      R2Fe(N, B) anisotropic magnet powder with an average grain diameter of 1 to 10 μm, having R2, Fe, and N or B as its main ingredients, the surface of the constituent grains of R2Fe (N, B) anisotropic magnet powder being coated with a #2 surfactant; and
   (C) 1 to 10 mass % of a resin as binder
is heated to a temperature above the softening point of the said resin, and while keeping that resin in a softened state or melted state, an orienting magnetic field is applied so that the R1FeB coarse powder and R2Fe(N, B) fine powder are oriented; and
(2) A molding process in which, after the said heat orientation process, the mixture is heated and press molded;
   this production method having the special feature that a composite rare-earth anisotropic bonded magnet is obtained in which the said R2Fe (N, B) fine powder and said resin are evenly filled into the gaps between constituent grains of the said R1FeB coarse powder.

It is suitable for the above-mentioned mixture to be comprised of a compound in which the surface of the constituent grains of the said R1FeB coarse powder are coated by a coating layer in which the said R2Fe(N, B) fine powder is evenly dispersed in the said resin.

As stated above, due to the R2Fe(N, B) fine powder and resin being evenly dispersed around the said R1FeB coarse powder, even if the molding pressure when molding the bonded magnet is relatively low, a bonded magnet is obtained which has sufficiently high density and extremely high magnetic properties. This decrease in molding pressure contributes to decreased manufacturing cost, due to cutting equipment expenses and shortening manufacturing process time. Further, uneven distribution of R2Fe (N, B) fine powder during magnetic field heat molding is eliminated, and R2Fe (N, B) fine powder is both evenly and quickly supplied between the constituent grains of R1FeB coarse powder. Also, a higher filling factor and an effect of high deterrence of fractures in the R1FeB coarse powder are easily attained under low pressure, and a quality bonded magnet stable with respect to magnetic properties and corrosion resistance is easily obtained.

This sort of compound, for example, is obtained after a heat kneading process in which the above R1FeB coarse powder, above R2Fe (N, B) fine powder, and above resin are heat kneaded at a temperature above the softening point of the said resin.

That is, such a compound is obtained by the production method for the composite rare-earth anisotropic bonded magnet compound of the present invention, that production method comprising:
(1) A mixing process which mixes
   (A) 50 to 84 mass % of R1FeB coarse powder, comprising
      R1FeB anisotropic magnet powder with an average grain diameter of 50 to 400 μm, obtained by performing a hydrogenation treatment on an R1FeB alloy having R1, Fe, and B as its main ingredients, the surface of the constituent grains of R1FeB anisotropic magnet powder being coated with a #1 surfactant; and
   (B) 15 to 40 mass % of R2Fe(N, B) fine powder, comprising
      R2Fe(N, B) anisotropic magnet powder with an average grain diameter of 1 to 10 μm, having R2, Fe, and N or B as its main ingredients, the surface of the constituent grains of R2Fe (N, B) anisotropic magnet powder being coated with a #2 surfactant; and
   (C) 1 to 10 mass % of a resin as binder; and
(2) A heat kneading process in which the mixture obtained after the said mixing process is heat kneaded at a temperature above the softening point of the said resin;
   this production method having the special feature that a compound is obtained in which the surface of the constituent grains of the said R1FeB coarse powder is coated by a coating layer in which the said R2Fe(N, B) fine powder is evenly dispersed in the said resin.

Each process necessary for molding the bonded magnet may be performed consecutively in single steps, or in multiple steps considering factors such as productivity, dimensional accuracy, and consistent quality. For example, the heat orientation process and subsequent molding process may be performed consecutively in one molding die (one step molding), or in a different molding die (two steps molding). Pressurizing may be performed during the heat orientation process. Further, the process of weighing ingredients (mixture powder or the compound of the present invention) may be performed with a separate die (three steps molding). In the case of this three step molding, it is possible to fill the cavity of the molding die with the above compound and then press mold, making the mixture prior to the heat orientation process into a preparative compact (or a green compact). The heat orientation process may be performed on this preparative compact. In this manner, by performing the processes necessary for molding the bonded magnet in multiple steps, it is easy to design improvements in productivity, and equipment flexibility will also increase.

In the above production method, the reason for establishing a heat orientation process is that by orienting each anisotropic magnet powder, a bonded magnet with high magnetic properties is obtained. Also, in the case of bonded magnets in which high magnetic properties are sought, the required magnetic field direction is determined in response to the application of the magnet. The greater the fluidity of each magnet powder during this heat orientation process, the more a bonded magnet with excellent magnetic properties will be obtained. So, for example, in the case of thermosetting resin, it is more suitable to heat above the hardening point of that thermosetting resin, and perform the above heat orientation process with the resin in a state of increased fluidity.

(Other)

The present invention may also be understood as the bonded magnet or compound obtained by performing the above production method.

The present invention may also be a composite rare-earth anisotropic bonded magnet with the special feature that it is obtained by the production method for the above composite rare-earth anisotropic bonded magnet.

Or, the present invention may also be a composite rare-earth anisotropic bonded magnet compound with the special feature that it is obtained by the production method for the above composite rare-earth anisotropic bonded magnet compound.

### BRIEF DESCRIPTION OF THE DRAWINGS

FIG. 1A: A figure that schematically shows the composite rare-earth anisotropic bonded magnet compound involved in the present invention.

FIG. 1B: A figure that schematically shows a conventional bonded magnet compound.

FIG. 2A: A figure that schematically shows the composite rare-earth anisotropic bonded magnet involved in the present invention.

FIG. 2B: A figure that schematically shows a conventional bonded magnet.

FIG. 3: A graph that shows the relationship between molding pressure and relative density.

FIG. 4: A scanning electron microscope (SEM) 2D electronic image photograph observing the composite rare-earth anisotropic bonded magnet involved in the present invention; it takes notice of metallic powder in the bonded magnet.

FIG. 5: An Nd electron probe microanalysis (EPMA) image photograph observing the composite rare-earth anisotropic bonded magnet involved in the present invention; it takes notice of the Nd element in the NdFeB magnet powder.

FIG. 6: An Sm electron probe microanalysis (EPMA) image photograph observing the composite rare-earth anisotropic bonded magnet involved in the present invention; it takes notice of the Sm element in the R2Fe(N, B) anisotropic magnet powder.

### BEST MODE FOR CARRYING OUT THE INVENTION

### A. Mode for Carrying Out

Example embodiments are given below, explaining the present invention in more detail. The contents of the below explanation, fittingly, corresponds not only to the bonded magnet of the present invention, but also to the compound and to the production methods for the bonded magnet and compound.

(1) R1FeB Anisotropic Magnet Powder

1. R1FeB anisotropic magnet powder is powder obtained by performing a hydrogenation treatment on an R1FeB alloy having R1, Fe, and B as its main ingredients.

The hydrogenation treatment stated in the present invention is an HDDR treatment method (hydrogenation-decomposition-disproportionation-recombination) or d-HDDR treatment method.

The HDDR treatment method is chiefly comprised of two steps. Namely, it is comprised of a first step (hydrogenation step) in which the three-phase decomposition (disproportionation) reaction is performed, maintaining 500 to 1000° C. in a hydrogen gas atmosphere of about 100 kPa (1 atm), and a dehydrogenation step (second step) in which after the first step, a vacuum is formed and dehydrogenation carried out. The dehydrogenation step is a step with an atmosphere whose hydrogen pressure is 10⁻¹ Pa or less. The temperature may be, for example, 500 to 1000° C. The hydrogen pressure stated in the present specification means the partial pressure of hydrogen unless specifically stated otherwise. Accordingly, as long as the hydrogen pressure during each process is within the prescribed value, either a vacuum atmosphere or a mixed atmosphere with inert gas are both acceptable. With respect to the HDDR treatment itself, one may duly refer to Japanese Patent Application Laid-Open (Kokai) No. 7-68561, Patent No. 2576671 where it is disclosed in detail.

On the other hand, as also reported in detail in public domain literature (Mishima et al: Journal of the Magnetics Society of Japan, 24(2000), p.407), the d-HDDR treatment is performed by controlling the speed of the reaction between an R1FeB alloy and hydrogen from room temperature to high temperature. Specifically, it is chiefly comprised of four steps including a low-temperature hydrogenation step (step 1) in which hydrogen is sufficiently absorbed into the R1FeB alloy at room temperature, a high-temperature hydrogenation step (step 2) in which the 3-phase decomposition (disproportionation) reaction occurs under low hydrogen pressure, an evacuation step (step 3) in which hydrogen is dissociated under as high a hydrogen pressure as possible, and a desorption step (step 4) in which the hydrogen is extracted from the material following step 3. The d-HDDR treatment differs from the HDDR treatment in that with the d-HDDR treatment, through the preparation of multiple steps with different temperatures and hydrogen pressures, the reaction speed of the R1FeB alloy and hydrogen can be kept relatively slow, and homogeneous anisotropic magnet powder is obtained.

More specifically, the low-temperature hydrogenation step, for example, maintains a hydrogen gas atmosphere with hydrogen pressure 30-2000 kPa at 600° C. or less. The high-temperature hydrogenation step maintains a hydrogen gas atmosphere with hydrogen pressure 20-100 kPa at 750-900° C. The evacuation step maintains a hydrogen gas atmosphere with hydrogen pressure 0.1-20 kPa at 750-900° C. The desorption step maintains a hydrogen gas atmosphere with hydrogen pressure 10⁻¹ Pa or less.

By using this sort of above-mentioned HDDR treatment method or d-HDDR treatment method, R1FeB anisotropic magnet powder can be mass produced at an industrial level. In particular, the d-HDDR treatment method is desirable from the viewpoint of mass producing high performance magnet powder with increased anisotropy.
2. The reason for the average grain diameter of R1FeB anisotropic magnet powder being 50 to 400 μm is that below 50 μm, coercivity (iHc) decreases, and when exceeding 400 μm residual magnetic flux density (Br) deteriorates. It is more desirable for the average grain diameter to be 74 to 150 μm.

Also, the reason for the mixture ratio being 50-84 mass % is that at less than 50 mass % maximum energy product (BH)max deteriorates, and when exceeding 84 mass % there is relatively little ferromagnetic fluid layer, and the effect of suppressing permanent flux loss will fade. It is more desirable if that mixture ratio is 70-80 mass %. The mass % stated in the present specification means the ratio when the whole of the bonded magnet or the whole of the compound is 100 mass %.
3. The composition of R1FeB anisotropic magnet powder, while not particularly limited, has 11-16 atomic % (at %) R1, 5.5-15 at % B, and Fe as the main ingredients, and fittingly, unavoidable impurities. R1₂Fe₁₄B in main phase is representative. In this case, with less than 11 at % R1, a —Fe phase precipitates and magnetic properties deteriorate, and when exceeding 16 at % R1₂Fe₁₄B phase decreases and magnetic properties deteriorate. And, with 5.5 at % or less of B, soft magnetic R1₂Fe₁₇ phase precipitates and magnetic properties decrease, and when exceeding 15 at % the volume fraction of the B-rich phase in the magnet powder increases, R1₂Fe₁₄B phase decreases and magnetic properties decrease, which is undesirable.

This R1 is comprised of scandium (Sc), yttrium (Y), and lanthanoid. For that matter, for an element with exceptional magnetic properties, it is best for R1 to be comprised of one or more of lanthanum (La), cerium (Ce), praseodymium (Pr), neodymium (Nd), samarium (Sm), gadolinium (Gd), terbium (Tb), dysprosium (Dy), holmium (Ho), erbium (Er), thulium (Tm) and lutetium (Lu). This point is the same with respect to the R2 mentioned later. Particularly from the perspective of cost and magnetic properties, it is preferable if R1 is comprised mainly of one or more of Nd, Pr, and Dy.

Further, in the R1FeB anisotropic magnet powder having to do with the present invention, separate from the above-mentioned R1, it is desirable to include at least one or more of the rare earth elements (R3) Dy, Tb, Nd, and Pr. Specifically, taking the whole of each magnet powder as 100 at %, it is desirable to include 0.05-5.0 at % of R3. These elements raise the initial coercive force of the R1FeB anisotropic magnet powder, and also exhibit an effect on controlling aging loss in the bonded magnet. The same is true for the R2Fe(N, B) anisotropic powder mentioned later, for example, R1 and R2 may be identical.

When there is less than 0.05 at % R3, there is little increase in initial coercive force, and when exceeding 5 at % a deterioration in (BH)max occurs. It is desirable to have 0.1 to 3.0 at % of R3.

In the R1FeB anisotropic magnet powder of the present invention, separate from the above-mentioned R1, it is desirable to include La. Specifically, taking the whole of each powder as 100 at %, it is desirable to include 0.001 to 1.0 at % of La. By doing so, aging loss of the magnet powder and the bonded magnet will be controlled. The same is true with respect to the R2Fe(N, B) anisotropic magnet powder mentioned later.

La has an effect on control of aging loss because La is the element with the greatest oxidation electrical potential among the rare-earth (R.E.) elements. Therefore, using La as a so-called ‘oxygen-getter’, La is oxidized prior to the above-mentioned R1 (Nd, Dy, etc.), and accordingly oxidation of the magnet powder and bonded magnet including La is controlled.

La exhibits an improving effect on heat resistance when included in small quantities that exceed the level of unavoidable impurities. The level of La unavoidable impurities is less than 0.001 at %, so in the present invention, the amount of La used is 0.001 at % or more. On the other hand, when La exceeds 1.0 at %, it invites an undesirable decrease in iHc. So, when the lower limit of the amount of La is 0.01 at %, 0.05 at %, or 0.1 at %, an ample improving effect on heat resistance is exhibited, which is desirable. From the standpoint of improving heat resistance and controlling iHc deterioration, it is even more desirable for the quantity of La to be 0.01 to 0.7 at %. Also, when there is 10.8 to15 at % B in the R1FeB anisotropic magnet powder, the composition of the magnet powder including La is not an alloy composition in which the R1₂Fe₁₄B₁ phase can be made to exist as either a single phase or nearly single phase, but becomes an alloy composition comprised of a multiphase composition of R1₂Fe₁₄B₁ phase and B-rich phase.

The R1FeB anisotropic magnet powder may include various elements other than R1, B and F that improve the magnetic properties of the powder.

For example, it is desirable to include either or both of 0.01 to 1.0 at % gallium (Ga) and 0.01 to 0.6 at % niobium (Nb). By including Ga, the coercive force of R1FeB anisotropic magnet powder improves. When the amount of Ga included is less than 0.01 at %, the effect of improving coercive force is not obtained, and when exceeding 1.0 at % coercive force is conversely decreased. By including Nb, it is possible for the reaction speed of phase transformation and opposite phase transformation during the hydrogenation treatment to be easily controlled. When the amount of Nb included is less than 0.01 at %, it is difficult to control the reaction speed, and when the amount of Nb exceeds 0.6 at % the coercive force is diminished. In particular, when Ga and Nb within the above-mentioned limits are included together, coercive force and anisotropy can both be improved in comparison to including only one or the other, and (BH) max is improved as a result.

It is desirable to include in sum total 0.001-5.0 at % of one, two or more elements from among aluminum (Al), silicon (Si), titanium (Ti), vanadium (V), chromium (Cr), manganese (Mn), nickel (Ni), copper (Cu), germanium (Ge), zirconium (Zr), molybdenum (Mo), indium (In), tin (Sn), hafnium (Hf), tantalum (Ta), tungsten (W), and lead (Pb). By including these elements, it is possible to improve the squareness ratio and coercive force of the obtained magnet. When the amount included is less than 0.001 at %, the effect of improving magnetic properties does not manifest, and when exceeding 5.0 at %, the precipitation phase precipitates and coercive force declines.

Further, it is desirable to include 0.001 to 20 at % of cobalt (Co). By including cobalt, it is possible to increase the Curie temperature of the bonded magnet, and temperature properties are improved. If the amount of Co included is less than 0.001 at %, the effect of including Co can not be seen, and when exceeding 20 at % the residual magnetic flux density decreases, and magnetic properties decrease.

The method of preparing the ingredient alloy of Co-less R1 d-HDDR anisotropic magnet powder is not particularly restricted, but as a general method, prepare the respective ingredients in the prescribed composition using high purity alloy ingredients. After mixing those ingredients, melt with each melting method, such as a high frequency melting method, then cast and make alloy ingots. The coarse powder made from these pulverized ingots may be used as the raw ingredient alloy. It is also possible to perform homogenization treatment on the raw ingredient ingots, and then take as the raw ingredient alloy an alloy in which distortions in the composition distribution have been diminished. Additionally, it is possible to pulverize the ingots which have been homogenization treated and take this coarse powder as the raw ingredient alloy. Powderizing which is performed after ingot pulverization and/or the above-mentioned hydrogenation treatment can be performed using either wet or dry machine pulverizing (jaw crusher, disc mill, ball mill, vibrating mill, jet mill, etc.).

It is effective to also include the above-stated Dy, Tb, Nd or Pr(R3), La, Ga, Nb, Co, etc. alloy elements in the raw materials alloy during the above-mentioned preparation. Naturally, as stated above, because R3 and La are elements that improve the heat resistance of R1FeB anisotropic magnet powder, it is desirable for La to exist on the surface or in the vicinity of the constituent grains of magnet powder. Accordingly, rather than including R3 and La in the raw ingredient alloy from the beginning, by mixing the R3 powder and La powder into the R1FeB anisotropic magnet powder during or following production of the magnet powder, and dispersing the La inside or on the surface of the magnet powder, magnet powder with more outstanding heat resistance is obtained.

That R3 magnet powder should include the above-mentioned R3, comprised of at least, for example, one or more of R3 simple, R3 alloy, R3 compound or each of those materials in hydrogenated form. The La magnet powder should similarly include La comprised of at least, for example, one or more of La simple, La alloy, La compound, or each of those materials in hydrogenated form. For the R3 alloy and La alloy, it is desirable if, carefully considering the influence on magnetic properties, they are made from an alloy of transition-metal element (TM) and La, compound (including intermetallic compound), or those materials in hydrogenated form. To give some concrete examples, there are LaCo(Hx), LaNdCo(Hx), LaDyCo(Hx), R3Co(Hx), R3NdCo(Hx), R3DyCo(Hx), etc.

When those magnet powders are made from an alloy or compound (including hydrogenated material), it is most suitable for the R3 and La included in those alloys to be 20 at % or more, or 60 at % or more. When R3 and La is dispersed on the surface of or within the magnet powder, for example, that dispersion can be performed via a dispersion heat treatment process in which a powder mixture made up of R3 powder and/or La powder mixed into R1FeB magnet powder is heated to 673 to 1123K. This dispersion heat treatment process may be performed after mixing of the R3 powder and La powder, or at the same time as the mixing. When the treatment temperature is less than 673K, it is difficult for the R3 powder and/or La powder to change to liquid phase, and ample dispersion treatment is a problem. On the other hand, when the temperature exceeds 1123K, crystal grain growth in the R1FeB anisotropic magnet powder is produced, inviting a deterioration in iHc, and heat resistance (permanent flux loss ratio) can not be sufficiently improved. It is desirable for the time of the treatment to be 0.5 to 5 hours. At less than 0.5 hours the dispersion of R3 and/or La is insufficient, and heat resistance of the magnet powder does not see much improvement. On the other hand, exceeding 5 hours will invite a deterioration in iHc.

And, though it goes without saying, it is desirable for this dispersion heat treatment process to be performed in an oxidation-inhibited atmosphere (for example, a vacuum atmosphere). When this dispersion heat treatment process is merged with the dehydrogenation step of the HDDR treatment, or with the no.1 evacuation step or no.2 evacuation step of the d-HDDR treatment, the treatment temperature, treatment time, and treatment atmosphere should be adjusted within limits common to both the HDDR/d-HDDR treatment and the dispersion heat treatment process.

When performing these treatments, the shape (grain diameter, etc.) of the R1FeB magnet powder, R3 magnet powder, or La magnet powder does not matter, but from the viewpoint of efficiently proceeding with the dispersion heat treatment process, it is most suitable if the R1FeB magnet powder has an average grain diameter of 1 mm or less, and the R3 powder and La powder have average grain diameters 25 μm or less. Also, this R1FeB magnet powder, depending on the suitable progression of hydrogenation treatment, is hydrogenated material, magnet powder, material with three-phase analyzed composition, or any of those materials in re-crystallized form.

When adding R3 or La during the production of R1FeB magnet powder, the companion ingredient R1FeB anisotropic magnet powder has to a greater or lesser extent changed to a hydrogenated state (hereafter, this magnet powder of hydrogenated material is called “R1FeBHx powder”). The reason being, R3 and La are added after the hydrogenation stage, either before the de-hydrogenation stage is complete or after the high temperature hydrogenation stage, before the No. 2 evacuation stage is complete. This R1FeBhx magnet powder is in a state in which, in comparison to a state not including oxygen, R1 and Fe are unusually difficult to oxidize. Therefore, it is possible to perform the dispersion and coating of R3 and La in a state in which oxidation is controlled, and a bonded magnet with excellent heat resistance is consistently obtained. For the same reason, it is desirable for R3 powder and La powder to be material in a hydrogenated state. For example, R3CoHx and LaCoHx are good.

To obtain the bonded magnet with excellent magnetic properties of the present invention, it is desirable for the Co-less R1 d-HDDR anisotropic magnet powder to be 279.3 kJ/m³ or greater, or 344 kJ/m³ or greater.

The matters stated above are the same in the case of the R2Fe(N, B) anisotropic magnet powder mentioned later, particularly the case of R2FeB anisotropic magnet powder.

(2) R2Fe(N, B) Anisotropic Magnet Powder

1. R2Fe(N, B) anisotropic magnet powder fills gaps in the coarse R1FeB anisotropic magnet powder, which has the effect of improving the magnetic properties of the bonded magnet, in particular maximum energy product. As stated above, R2FeN anisotropic magnet powder and R2FeB anisotropic magnet powder are included in this R2Fe(N, B) anisotropic magnet powder, which is comprised of at least one of those two powders. In either case, the grain diameter of R2Fe(N, B) anisotropic magnet powder is relatively smaller than that of R1FeB anisotropic magnet powder.

That composition of that powder is not particularly limited, and appropriately, may contain unavoidable impurities. A representative composition has Sm₂Fe₁₇N as main phase. In the case of R2Fe (N, B) anisotropic magnet powder also, other than the main ingredients, various elements may be included which improve the magnetic properties of the bonded magnet.

SmFeN magnet powder, which is one R2Fe(N,B) powder, may for example be obtained by the following method. Perform solution treatment on an Sm—Fe alloy with the requested composition, and pulverize in nitrogen gas. After pulverization, perform nitriding treatment in an NH₃+H₂ gas mixture and then cool. If fine pulverized by jet mill, etc, 10 μm or less SmFeN fine magnet powder is obtained.
2. This SmFeN magnet powder generates high coercivity by creating a grain diameter which will be single domain particle size. From this viewpoint, the average grain diameter of R2Fe (N, B) anisotropic magnet powder was made 1 to 10 μm. At less than 1 μm, (1) the powder becomes easily oxidized, and (2) residual magnetic flux density decreases and maximum energy product (BH)max also decreases, which is undesirable. When surpassing 10 μm, (1) a single domain particle is not obtained, and (2) coercivity decreases, which is undesirable.

The reason for making that mixture ratio 15 to 40 mass % is that at less than 15 wt %, the quantity is too little to fill between the constituent grains of R1FeB anisotropic magnet powder. On the other hand, when exceeding 40 wt %, R1FeB anisotropic magnet powder becomes relatively less of the mixture, and maximum energy product(BH)max will decrease.

Further, to obtain the bonded magnet of the present invention having excellent magnetic properties, 303.2 kJ/m³ or greater, or 319 kJ/m³ or greater is desirable for the R2Fe(N, B) anisotropic magnet powder.

(3) Surfactant and Resin

1. Surfactant is used in order to increase fluidity in the resin of the R1FeB anisotropic magnet powder and R2Fe(N, B) anisotropic magnet powder when heat molding the bonded magnet. By doing so, high levels of lubrication, filling, and orientation are manifested at the time of heat molding, and a bonded magnet with excellent magnetic properties and corrosion resistance is obtained.

In particular, focusing on R1FeB coarse magnet powder with large grain diameter, at the time of the above-mentioned heat molding, due to the presence of #1 surfactant which coats the complete grain surface of that powder, the R1FeB coarse magnet powder exists in a state in which it floats in a sea of the ferromagnetic fluid layer. As a result, even when molding the bonded magnet from R1FeB anisotropic magnet powder which is highly susceptible to fractures, the constituent grains of that powder easily rotate, stress concentration is greatly alleviated, and advancement of micro-cracks is prevented.

Also, by coating the R2Fe(N, B) anisotropic magnet powder with surfactant, the bonding of binder resin and R2Fe (N, B) anisotropic magnet powder is strengthened. That is, the resin and powder become one body, and the above-mentioned ferromagnetic fluid layer behaves more as a pseudo-fluid body. And due to the presence of #2 surfactant, the R2Fe(N, B) anisotropic magnet powder is in a state in which it is evenly dispersed in the resin, also contributing greatly to increasing the relative density and magnetic properties of the bonded magnet.

Thus, surfactant is indispensable for not only the R1FeB anisotropic magnet powder, but also for the R2Fe(N, B) anisotropic magnet powder.

In the case of the present invention, the surfactant which coats the grain surface of R1FeB anisotropic magnet powder and the surfactant which coats the grain surface of R2Fe (N, B) anisotropic magnet powder are distinguished for the sake of convenience, but these surfactants may be either the same or different. If a common surfactant is used the coating treatment will be simple, which is desirable for production.

The type of surfactant is not particularly limited, but is decided after carefully considering the type of resin to be used as a binder. For example, if that resin is epoxy resin, it possible to use either a titanate coupling agent or silane coupling agent as surfactant. Other than these, if employing phenol resin, a silane coupling agent can be used as a combination of resin and surfactant.
2. The resin used in the present invention serves a role as a binder in the bonded magnet. It is not limited to thermosetting resin; thermoplastic resin may also be used. For thermosetting resins there are, for example, the above-mentioned epoxy resins and phenol resins; and for thermoplastic resins there are, for example, nylon 12 and polyphenolene sulfides.

The resin compounding ratio, which is 1-10 mass % in the present invention, lacks binding power at less than 1 mass %, and when surpassing 10 mass % high (BH)max magnetic properties deteriorate.
3. In the present invention, each magnet powder coated by surfactant is called R1FeB coarse powder and R2Fe(N, B) fine powder, but “coarse” powder and “fine” powder are used only for the sake of conveniently naming the respective relative grain diameters. R1FeB coarse magnet powder, for example, is obtained by a #1 surfactant process in which a solution of R1FeB anisotropic magnet powder and the above #1 surfactant are dried after stirring. Likewise, R2Fe(N, B) fine powder, for example, is obtained by a #2 surfactant process in which a solution of R2Fe(N, B) anisotropic magnet powder and the above #2 surfactant are dried after stirring. The surfactant layer thus obtained has a thickness of 0.5 to 2 μm, and coats the entire surface of each powder grain.
   (4) Compound and Bonded Magnet

The compound of the present invention, for example, is obtained by mixing and then heat kneading the mixture of R1FeB coarse magnet powder, R2Fe (N, B) fine magnet powder and resin. The resulting compound has a granular shape with average grain diameter 50-500 μm.

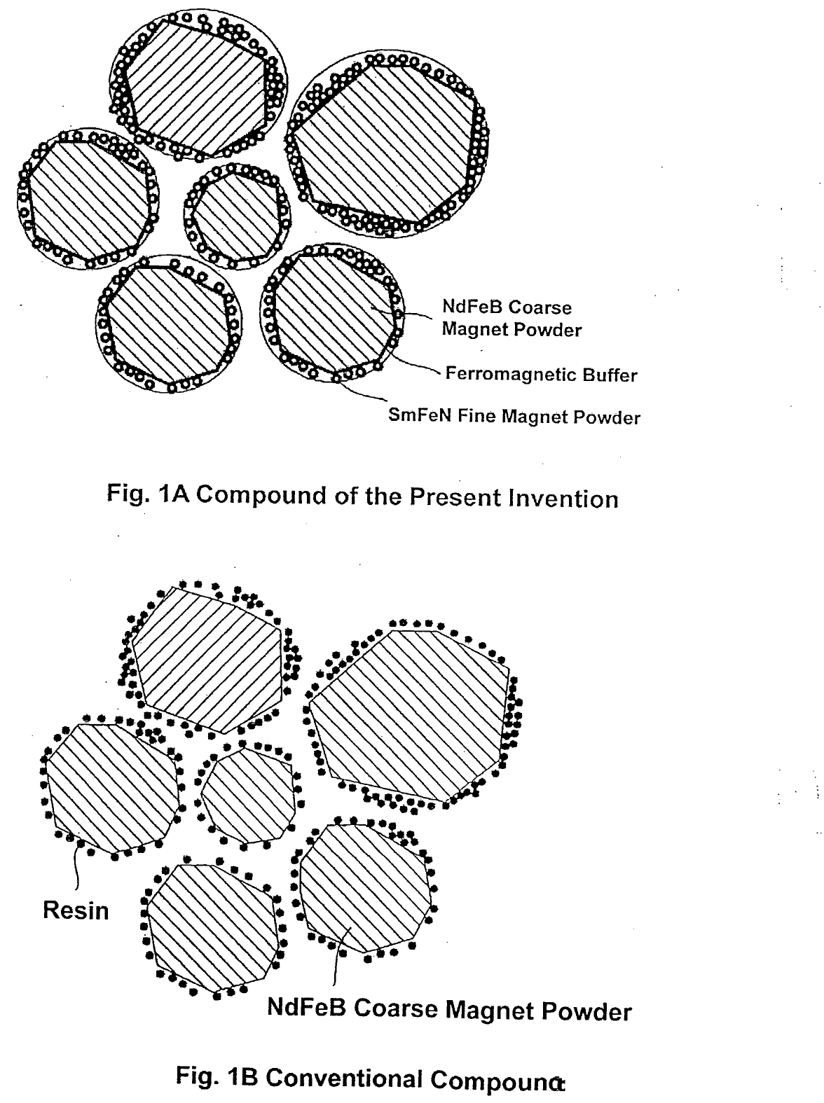

The appearance of the compound is schematically shown in FIG. 1A. This figure is schematically transcribed based upon an EPMA photograph taken by SEM observation of a compound made from coarse NdFeB magnet powder and fine SmFeN magnet powder, which are examples of the above mentioned magnet powders. FIG. 1B schematically shows the appearance of a conventional compound made from NdFeB magnet powder and resin. As understood from FIG. 1B, in the case of the conventional compound, resin simply adheres to the grain face of NdFeB magnet powder.

Whereas, as shown in FIG. 1A, in the case of the compound of the present invention, it is in a state in which the SmFeN fine powder, in a state in which the SmFeN magnet powder is enveloped in resin through the #2 surfactant, is evenly dispersed in the grain surface of NdFeB coarse powder, with the NdFeB coarse powder in a state in which the NdFeB magnet powder is coated by #1 surfactant. Moreover, the compound is in a state in which its periphery is further filled up by the resin. FIG. 1A shows a state in which each grain of NdFeB coarse powder is separated, but the compound stated in the present invention is not limited to such a condition. That is, the compound of the present invention may be comprised of a plural number of constituent grains of R1FeB coarse powder bound together, and it may also be comprised of a mixture of material with each grain separated and material with a plural number of grains bound together.

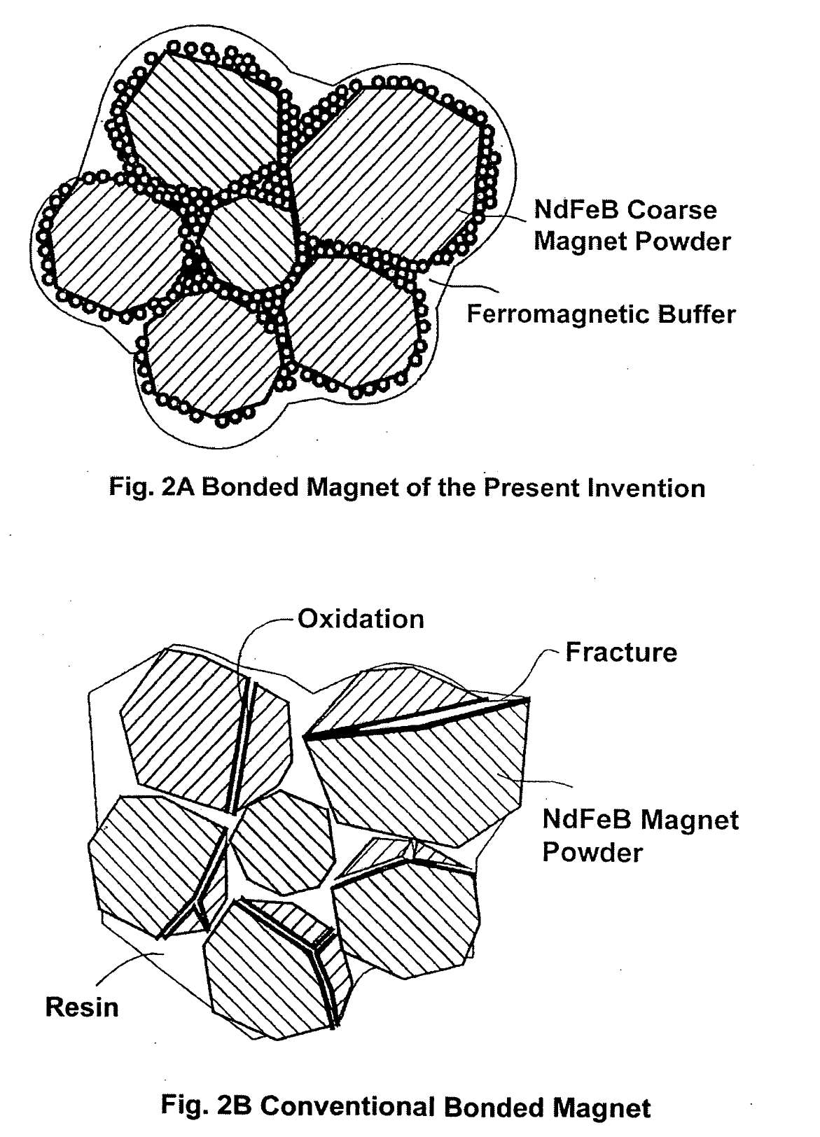

Next, FIGS. 1A, B and similarly FIGS. 2A, B schematically show one expanded part of the bonded magnet obtained by magnetic field heat molding. FIG. 2A shows the bonded magnet of the present invention, and FIG. 2B shows a conventional bonded magnet. As is clear from FIG. 2B, in the case of the conventional bonded magnet, when press molding, the grains of NdFeB magnet powder directly contact each other, and stress concentration occurs in the affected parts. As a result, NdFeB magnet powder, which has received hydrogenation treatment and has an increased susceptibility to fractures, produces micro-cracks and fractures due to those micro-cracks. An oxidation layer is formed on newly formed active fracture surfaces, which causes magnetic properties to deteriorate.

On the other hand, in the case of the bonded magnet of the present invention, as is clear from FIG. 2A, when magnetic field heat molding the bonded magnet the surface of each grain of NdFeB coarse magnet powder is in a state in which it is evenly enveloped by SmFeN fine powder and resin. To put it another way, it is in a state in which the space between each constituent grain of NdFeB coarse powder is densely filled with SmFeN fine powder and resin. As a result, the NdFeB coarse powder is in a state as if completely floating in the ferromagnetic fluid layer formed by the SmFeN fine powder and resin. Due to high fluidity from this ferromagnetic fluid layer, the grains of NdFeB coarse powder are placed in an environment in which they have excellent lubrication between each other, and a great degree of positional freedom is obtained between those grains. The ferromagnetic fluid layer existing between the constituent grains of NdFeB coarse powder plays the role of a so-called “cushion”, each constituent grain of NdFeB coarse magnet powder makes direct contact, and outbreak of local stress concentration is prevented. Doing so, the micro-cracks and fractures caused thereby which were generated within the conventional bonded magnet are controlled and prevented, and a bonded magnet with extremely low aging loss is obtained.

The case of heat molding a bonded magnet from a compound obtained by heat kneading R1FeB coarse powder, R2Fe (N, B) fine powder, and resin was explained, but the above matters are not limited to such a case.

I.e., the present invention confirms obtaining a bonded magnet with excellent magnetic properties and corrosion resistance, same as in the above instance, even in the case of directly filling the powder mixture of each magnet powder and resin into the cavity of the die and then heat molding, without using the above compound. Because soaking and close adaptation to the resin softened or melted by heating is greatly improved by coating the surface of each magnet powder with surfactant, it is thought that the fluidity of melted resin increases. In this case, it is more preferable to quickly place the resin in a melted or softened state, and so it is good to heat to a relatively high temperature. For example, in the case of using thermosetting resin, it is good from the magnetic field orientation step to heat above the hardening point and then mold.

Of course, it goes without saying that by using the above compound, even dispersion of R1FeB coarse powder in the ferromagnetic fluid layer improves further, and a bonded magnet with high magnetic properties and corrosion resistance is more consistently obtained.

Incidentally, the “fluidity” stated in the present specification is related to the filling, lubrication, and orientation of the R1FeB anisotropic magnet powder in the above ferromagnetic fluid layer; more specifically, it is related to the ease of movement of that powder's rotation and the degree of positional freedom.

This fluidity can be indicated by the viscosity of the compound used, shearing torque when molding the bonded magnet, or relative density of the bonded magnet when molding at a particular molding pressure. However, in the present specification, relative density was selected as an indicator of fluidity. The reason is that by using a sample itself with a measured relative density, permanent flux loss ratio, which is the objective, can be measured. Relative density is the ratio of the density of the molded body to the theoretical density determined by the mixture ratio of raw ingredients.

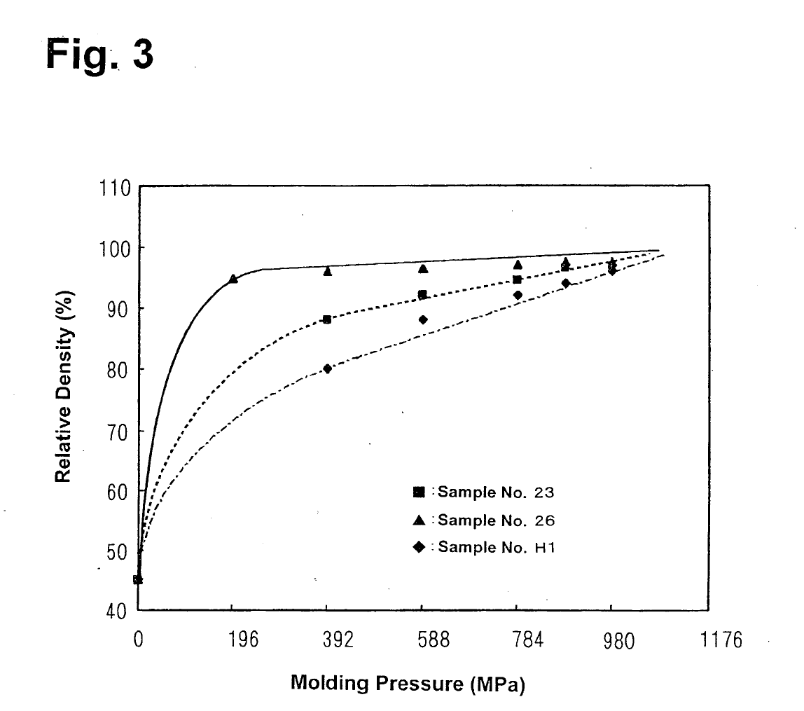

Next, FIG. 3 shows the actual results of investigating the relationship between molding pressure when molding under various molding pressures and the relative density of the molded bodies obtained. In the same figure, ▪ shows the relative density for various changes in molding pressure for sample No. 23 of the second example embodiment, mentioned later. Similarly, ▴ is the relative density with respect to sample No. 26, and ♦ is the relative density with respect to sample No. H1.

Sample No. 26 (▴) is the case of molding the bonded magnet using a compound in which NdFeB coarse powder on which surfactant has been conferred, SmFeN fine powder, and resin, were heat kneaded. In this case, the relative density increases suddenly from a low grade of molding pressure, and at a molding pressure of 198 MPa(2 tons/cm²), relative density virtually reaches saturation. Therefore, it is possible to mold a bonded magnet having the desired properties with an unusually low molding pressure. In other words, it manifests excellent low pressure moldability. This decrease in molding pressure is not merely an improvement in manufacturability, it also has an effect on further controlling fractures in the R1FeB anisotropic magnet powder, and improving corrosion resistance (permanent flux loss ratio) due to a decrease in the amount of oxygen included, which causes an improvement in the filling factor. Further, due to pulling the filling factor up near the limit and improvements in orientation due to high fluidity, it is possible to improve magnetic properties, represented by(BH)max, to an extremely high level.

Sample No. 23 (▪) is the case of heat kneading each magnet powder and resin at room temperature and magnetic field heat molding. In this case, build up of relative density from molding pressure is sluggish, and low pressure moldability like that in sample No. 26 (▴) is not obtained. Accordingly, relatively high molding pressure must be used to obtain the desired bonded magnet. Even in this case, as is clear from looking at Chart 5, the magnet has sufficiently excellent corrosion resistance (permanent flux loss ratio).

Sample No. H1 (♦) is the case of not performing either heat kneading or magnetic field heat molding. That is, the case of kneading at room temperature and press molding. In this case, build up of relative density from molding pressure is more sluggish, and low pressure moldability is not obtained. Further, as is clear from looking at Chart 5, both corrosion resistance (permanent flux loss ratio) and magnetic properties were not particularly outstanding.

As in the case of sample No. 26 (▴), it is thought that the reason that very outstanding magnetic properties and corrosion resistance are obtained even with a bonded magnet molded at low pressure has a great deal to do with the ferromagnetic fluid layer which appears during magnetic field heat molding. As previously stated, this ferromagnetic fluid layer, in which R2Fe (N, B) fine magnet powder is dispersed in resin, surrounds the R1FeB coarse powder. It is possible to divide the main functions of this ferromagnetic fluid layer mainly into fluidity and even dispersion.

Fluidity contributes to improvement of easy rotation and easy positional control of each magnet powder. It increases the filling factor of anisotropic magnet powder, and moreover, works to deter fractures in the R1FeB coarse magnet powder during molding. As previously stated, improvements in filling factor and orientation improve (BH) max and permanent flux loss ratio, and the deterrence of fractures in the R1FeB coarse magnet powder improves permanent flux loss ratio.

Even dispersion contributes to shortening the moving distance of R2Fe (N, B) fine powder and resin when molding the bonded magnet, and to deterring uneven distribution of the R2 fine magnet powder. Together, these benefits fill gaps formed between constituent grains of the R1FeB coarse powder and improve the filling factor, increasing (BH)max and permanent flux loss ratio of the bonded magnet. Shortening the moving distance of R2Fe (N, B) fine powder decreases molding pressure and increases low pressure moldability, contributing to an increase in the manufacturability of the bonded magnet. Deterrence of uneven distribution in the R2Fe (N, B) fine powder adds improved manufacturability along with this low pressure moldability, and with an effect also on deterring fractures in the R1FeB coarse powder, contributes to improving permanent flux loss ratio of the bonded magnet. Due to this deterrence of uneven distribution, evenness of the magnet's surface magnetic flux is maintained, and it is easy to stabilize the quality of the bonded magnet during mass production.

In order to make it possible to objectively compare the ferromagnetic fluid layer function which appears when molding the bonded magnet, in the present specification a relative density when the bonded magnet was molded under prescribed conditions is used.

Chiefly from the viewpoints of orientation, filling factor and deterrence of fractures, when indicating the above-mentioned fluidity which influences (BH)max and permanent flux loss ratio, a relative density for the bonded magnet obtained when magnetic field heat molding under conditions of molding temperature 150° C., magnetic field 2.0 MA/m(2.5 T), and molding pressure 882 MPa (pressure conferred during final product molding in industrial manufacturing)is used.

As in the present invention, the relative density when sufficient fluidity is obtained is an extremely high value of 94 to 99%. When relative density is less than 94%, fluidity is insufficient, and both ease of rotation and ease of positional control for the R1FeB coarse powder and R2Fe(N, B) fine powder are low. Therefore, filling, orientation, and deterrence of fractures when molding the bonded magnet decrease, and a bonded magnet with excellent(BH)max and permanent flux loss ratio is not obtained. On the other hand, the upper limit of relative density is 99% or less because that is the manufacturing limit at commercial levels of production.

The relative density when more adequate even dispersion is conferred (for example, when heat kneading each magnet powder and resin) is an extremely high value of 95 to 99%. This is because by conferring even dispersion, due to shortening the moving distance of R2Fe(N, B) fine powder and resin, and preventing uneven distribution in the R2Fe (N, B) fine powder, fluidity increases further, and the filling factor and effect of deterring fractures further improve. As a result, a bonded magnet with even more outstanding (BH)max and permanent flux loss ratio is obtained.

Next, chiefly from the viewpoint of low pressure molding, when indicating the above-mentioned even dispersion which influences improvement in manufacturability, a relative density for the bonded magnet obtained when magnetic field heat molding under conditions of molding temperature 150° C., magnetic field 2.0 MA/m(2.5 T), and molding pressure 392 MPa is used.

The relative density when more adequate even dispersion is conferred (for example, when heat kneading each magnet powder and resin) is an extremely high value of 92 to 99%. When relative density is less than 92%, fluidity is insufficient, and the desired low pressure moldability can not be obtained. The reason for the upper limit of relative density being 99% or less is the same as stated above.

### B. EXAMPLES

### (a) Example No. 1

(Sample Production)

(1) Production of R1FeB Coarse Powder

1. Production of R1FeB Anisotropic Magnet Powder

As R1FeB anisotropic magnet powder used for the example embodiments concerning the present invention and comparison examples, samples having the compositions shown in Chart 1 and Chart 2 (NdFeB magnet powders) were produced by d-HDDR treatment. Specifically, prepared alloy ingot (30 kg) was first melted/cast and made into the composition shown in Chart 1 and Chart 2. Homogenization treatment was performed on this ingot in an argon gas environment at 1140 to 1150° C. for 40 hours (however, samples No. 5 and 6 are excepted). This ingot was pulverized by jaw crusher to coarse powder with average grain diameter of 10 mm or less. A d-HDDR treatment, comprised of a low-temperature hydrogenation step, high-temperature hydrogenation step, evacuation step, and desorption step, was then performed on this coarse powder under the following conditions. At room temperature, under hydrogen gas atmosphere with 100 kPa hydrogen pressure, hydrogen was adequately absorbed into the alloy of each sample alloy (low temperature hydrogenation step). Next, a 480 minute heat treatment was performed (high temperature hydrogenation stage) under an 800° C. 30 kPa (hydrogen pressure) hydrogen gas atmosphere. In succession, while holding at 800° C., a 160 minute heat treatment was performed (evacuation step) under a hydrogen gas atmosphere with 0.1 to 20 kPa hydrogen pressure. Last, a vacuum was pulled for 60 minutes with a rotary pump and dispersion pump, and then the material was cooled under a vacuum atmosphere of 10⁻¹ Pa or less (desorption step). Doing so, 10 kg of NdFeB magnet powder was made per respective batch. This average diameter is found by measuring the weight of each grade after sieve analysis, and taking the weighted average of those measurements. The same is true with respect to other average diameters stated in the present invention.

2. Surfactant Coating

To the thus obtained NdFeB magnet powder comprised of each composition, a solution of surfactant was added, and then vacuum dried while stirring (#1 coating process). For the surfactant solution, the silane coupling agent (made by Japan Yurika Corp., NUC silicon A-187) was doubly diluted in ethanol. However, with respect to sample No. 4, a solution with the titanate coupling agent (Ajinomoto Corp., Plenact KR41 (B)) doubly diluted in methylethylketone was used for the surfactant solution.

R1FeB coarse powder (NdFeB coarse powder) comprised of grains whose surface is coated by surfactant was thus obtained. However, surfactant coating was not performed with respect to sample No. C1 in Chart 2.

(2) Production of R2Fe(N, B) Fine Powder

As R2Fe (N, B) anisotropic magnet powder, for samples No. 1 to 8 in Chart 1 and each comparison example in Chart 2, publicly marketed SmFeN magnet powder (Sumitomo Metal Mining Co., Ltd.) was used. For samples No. 9 to 12 in Chart 1, likewise publicly marketed SmFeN magnet powder (Nichia Co.) was used. In the case of each sample, a solution of surfactant the same as stated above was added, and the mixture was vacuum dried while stirring (#2 coating process). Each type of R2Fe (N, B) fine powder (SmFeN fine powder), comprised of grains whose surface is coated by surfactant, was thus obtained. However, surfactant coating was not performed with respect to sample No. C2 in Chart 2.

The surfactant coating method is not limited to the method performed with respect to the above-mentioned NdFeB coarse powder and SmFeN fine powder. For example, a method may be adopted in which, after mixing R1FeB anisotropic magnet powder and R2Fe (N, B) anisotropic magnet powder with a Henshel mixer, surfactant solution is added, and the mixture is then vacuum dried while stirring.

(3) Production of Composite Rare-Earth Anisotropic Bonded Magnet Compound

Using the mixture ratio (mass %) shown in Chart 1 and Chart 2, the above-cited NdFeB coarse powder and SmFeN fine powder were respectively mixed with a Henshel mixer. Epoxy resin was added to that mixture in the ratios shown in Chart 1 and Chart 2 (mixing process), and a compound was obtained by performing heat kneading at 110° C. with a Banbury mixer (heat kneading process). For this kneading, besides the above Banbury mixer, other kneading machines may also be used.

The temperature at which that heat kneading process is performed is acceptable if above the softening temperature of the epoxy resin; for example, it can be performed at a temperature range of 90 to 130° C. At less than 90° C. the resin does not turn to a melted state and it is not possible to evenly disperse SmFeN fine powder in the resin. Even if the heat kneading temperature is above the hardening point of the resin, the resin coats around the magnet powder and can be evenly dispersed. In this case however, because the hardening of the resin advances, subsequent magnetic field orientation is impossible, and the magnetic properties of the bonded magnet can be drastically reduced after molding. Here, “evenly dispersed” means a state in which the epoxy resin is definitely present between the SmFeN fine powder and NdFeB coarse powder.

The resin used here has a softening point of 90° C., and hardening temperature (hardening point) of 150° C. The hardening temperature indicates the temperature at which 95% of the resin has completed the hardening reaction when heated for 30 minutes.

(4) Production of Composite Rare-Earth Anisotropic Bonded Magnet

Using each type of compound obtained, bonded magnets to use for magnetic measurements were produced. To mold the bonded magnets, heated press molding (molding process) was performed under conditions of molding temperature 150° C., magnetic field 2.0 MA/m(heat orientation process), and molding pressure 882 MPa(9 ton/cm²).

To confirm the low pressure molding of the present invention, heated press molding (molding process) was also performed under conditions of molding temperature 150° C., magnetic field 2.0 MA/m(heat orientation process), and molding pressure 392 MPa(4 ton/cm²). From these conditions a 7×7×7 mm cube-shaped molded body was obtained in each case.

Magnetizing was performed in a 4.0 T magnetic field by using a hollow coil and adding 10000 A exciting current to the molded body (magnetizing process), making the molded body into a compound rare-earth anisotropic bonded magnet. The method used in the molding process is not limited to compression molding; other generally known methods such as injection molding or extrusion molding may also be used.

(Sample Measurements)

(1) For the bonded magnets used for taking measurements, comprised of each sample shown in Chart 1 and Chart 2, magnetic properties, permanent flux loss ratio, and relative density were each measured. Specifically, as follows.

Maximum energy product of each sample bonded magnet obtained was measured with a BH tracer (Riken Electronics Sales Co., BHU-25). Permanent flux loss ratio was calculated by taking the difference between the initial magnetic flux of the molded bonded magnet and the magnetic flux obtained when remagnetizing the magnet after being held in a 100° C. atmospheric environment for 1000 hours, and then finding the ratio of that reduction in flux to the initial magnetic flux. A Model FM-BIDSC (DENSHI JIKI Co.) was used for measuring flux.

Relative density was calculated by the above-stated method. I.e., the density of the molded body was found by calculating the cubic volume, which is found from the dimensions in micrometers of the molded body after press molding, and measuring the weight of the molded body with an electronic balance. The relative density of the molded body was then calculated by dividing that relative density by the theoretical density of the molded body, which was found from the mixture ratio of magnet powder and resin used in each sample.

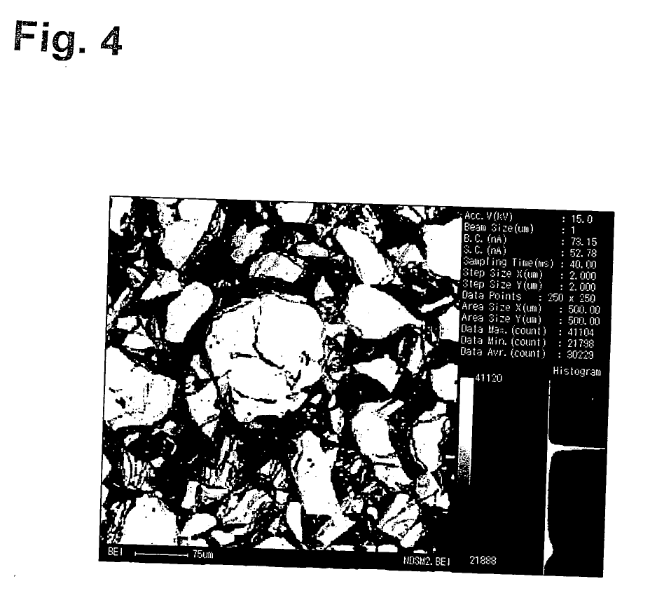

The results thus obtained are shown in Chart 3 and Chart 4.
(2) SEM observation photographs of the bonded magnet made from sample No.1 of Charts 1 are shown in FIGS. 4 through 6. These pictures were taken using an EPMA-1600 made by Shimadzu Corporation.

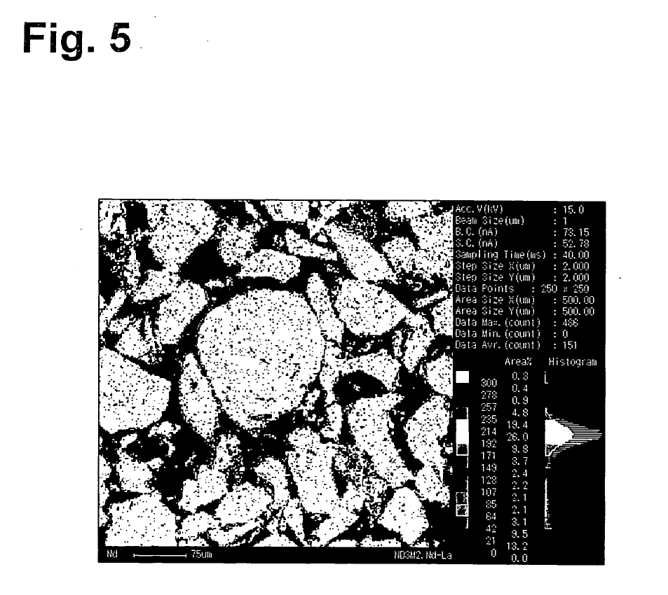

FIG. 4 shows a 2D electron image. FIG. 5 shows an Nd element EPMA image. In FIG. 5, a thickening concentration of the Nd element is shown in order from blue to yellow to red, and it is understood from the thickening of Nd in large diameter grains that those grains are grains of NdFeB powder.

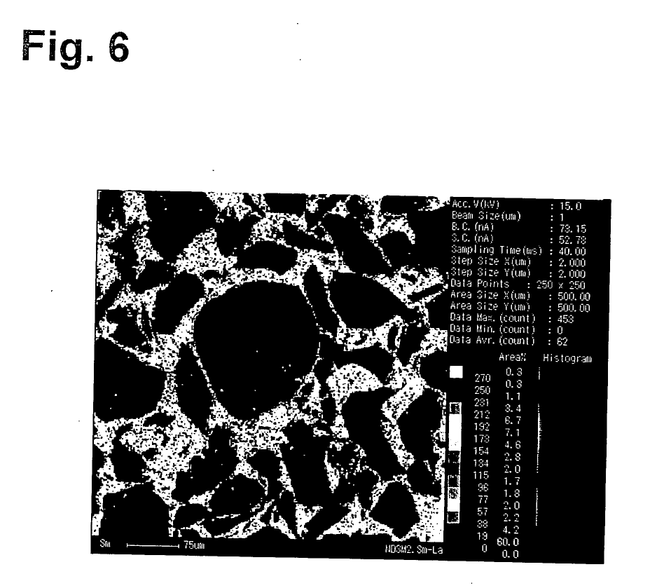

FIG. 6 is an EPMA image of the Sm element. In FIG. 6, a thickening concentration of the Sm element is shown in order from blue to yellow to red. From this figure, it is seen that the surrounding surfaces of all the large diameter grains (grains of NdFeB powder) are blanketed by grains of SmFeN powder, and that in the gaps formed between the large diameter grains comprised of NdFeB powder, small diameter grains of SmFeN powder are evenly and densely dispersed.

(Evaluation)

The following is understood from Charts 1 through 4.

### (1) EXAMPLE EMBODIMENTS

The samples for any of the example embodiments of samples No. 1 through 12 have the average grain diameter and mixture ratio stated in the present invention. Bonded magnets comprised of any of the samples show high magnetic properties with (BH)max of 144 kJ/m³ or more. With respect to permanent flux loss ratio, indicator of aging loss of the bonded magnet, all samples show excellent properties of 6.5% or less. Particularly, for permanent flux loss ratio under a 100° C. environment, all samples show excellent permanent flux loss ratio of 5% or less. And each sample shows a high relative density, which indicates the fluidity of the compound when heat molding the bonded magnet, of 92% or greater. Particularly, in the case of samples No. 1 through 12, the change in relative density due to differences in molding pressure is extremely small. In other words, even when molding at low pressure, sufficiently large relative density is obtained, i.e. the low pressure moldability of the present invention was confirmed.

Samples No. 1 to 3, 7 to 10, and 12 emphasized the ability to manage both magnetic properties and corrosion resistance. These composite rare-earth anisotropic bonded magnets show very excellent magnetic properties of (BH)max 168 kJ/m³ or greater. Further, along with those magnetic properties, those bonded magnets also exhibit a very excellent permanent flux loss ratio of −5.0%(100° C.), which could not be attained by conventional composite bonded magnets.

Based on the bonded magnets of above samples No. 1 through 3, a composite rare earth anisotropic bonded magnet with increased corrosion resistance suitable for use in a high temperature atmosphere is shown in sample No. 4. Although the (BH)max for this sample, 164 kJ/m³, is slightly lower compared the bonded magnets of samples No. 1 through 3, sample No. 4 shows excellent corrosion resistance with permanent flux loss ratio −4% or less (specifically, −3.3%).

Based on the bonded magnets of samples No. 1 through 3, composite rare earth anisotropic bonded magnets which aim to further improve corrosion resistance and decrease production cost are shown in samples No. 5 and 6. These bonded magnets aim to abbreviate the homogenization heat treatment and decrease production cost by increasing the amount of B included. By including La, which functions as an oxygen-getter, permanent flux loss ratio is further increased. Although the (BH)max for these samples of 145 kJ/m³ and 153 kJ/m³ is markedly low in comparison to the bonded magnets of samples No. 1 through 3, they both have very excellent corrosion resistance with a permanent flux loss ratio of −3.2%.

The bonded magnet of sample No.11 is a low cost type which decreases the amount of NdFeB magnet powder included, which is R1FeB coarse powder. Although the (BH)max of 144 kJ/m³ is markedly lower than that of the bonded magnets in samples No. 1 through 3, it continues to show excellent corrosion resistance, with a permanent flux loss ratio of −4.5%.

### (2) Comparison Examples

1. Sample No. C1 is the case of not applying surfactant coating to the NdFeB magnet powder of sample No.1. Sample No. C2 is the case of not applying surfactant coating to the SmFeN magnet powder of sample No.1. In either case, the relative density when molding at low pressure (392 MPa) is low. This is thought to be because the fluidity was low when heat molding the bonded magnet. Specifically, in the case of sample No. C1, it is thought due to the fact that because there was no surfactant coating on the surface of the NdFeB magnet powder, fluidity between the NdFeB magnet powder and ferromagnetic fluid layer was low during heat molding of the bonded magnet. Therefore, permanent flux loss ratio is inferior when molding at an ordinary industrial level molding pressure of 882 MPa. In the case of sample No. C2, it is thought to be because without a ferromagnetic fluid layer in which SmFeN magnet powder is adequately dispersed in the resin being formed at all, fluidity was low. Accordingly, permanent flux loss ratio is likewise inferior when molding at an ordinary industrial level molding pressure of 882 MPa.
2. Sample No. D1 is the case of the average grain diameter of the NdFeB magnet powder being too small. Sample No. D2 is the case of the average grain diameter being too large as opposed to sample No.4. In either case, (BH)max decreases greatly. Accordingly, to plan for improved magnetic properties, it is necessary for the average grain diameter of the NdFeB magnet powder to be within the range of the present invention.
3. Sample No. E1 is the case in which the mixture amount of NdFeB coarse powder was too small as opposed to sample No.1. Sample No. E2 is the case in which that mixture amount was too large. When the NdFeB coarse powder mixture amount is too small, the magnetic properties of that portion decrease. Conversely, when that mixture amount is large, the mixture amount of SmFeN fine powder grows relatively smaller, and it becomes impossible for the SmFeN fine powder to be evenly dispersed on the entire surface of the NdFeB coarse powder. As a result, the relative density (fluidity) when heat molding the bonded magnet will decrease, and the permanent flux loss ratio for that portion will also deteriorate.
4. Sample No. F1 is the case in which the mixture amount of SmFeN fine powder was too small as opposed to sample No. 4. Sample No. F2 is the case in which the mixture amount was too large. When the SmFeN fine powder mixture amount is too small, it becomes impossible for the SmFeN fine powder to be evenly dispersed on the entire surface of the NdFeB coarse powder, same as in sample No. E2. As a result, the relative density (fluidity) when heat molding the bonded magnet will decrease, and the permanent flux loss ratio and magnetic properties for that portion will also deteriorate. When there is much SmFeN fine powder, the amount of NdFeB coarse powder grows relatively smaller, and magnetic properties deteriorate, same as in sample No. E1.
5. Sample No. G1 is the case in which the mixture amount of epoxy resin was too small. Sample No. G2 is the case in which the epoxy resin mixture amount was too large. When the resin mixture amount is too small, formation of the ferromagnetic fluid layer when heat molding the bonded magnet is inadequate, fluidity of NdFeB coarse powder is lost, and permanent flux loss ratio decreases. When the resin mixture amount is too large, the mixture amount of NdFeB coarse powder becomes relatively less, and therefore there is a tendency for the magnetic properties of the bonded magnet to decline.

It is confirmed from the above that in order to obtain a bonded magnet with excellent magnetic properties and low ageing loss, R1FeB coarse powder such as NdFeB coarse powder, R2Fe(N, B) fine powder such as SmFeN fine powder, and resin must satisfy the average grain diameters and mixture ratios stated in the present invention.

### (b) Example No. 2

(Sample Production and Measurement)

The production conditions for the compound used in molding the bonded magnet (heat kneading temperature) and production conditions for the bonded magnet using that compound (molding temperature and molding pressure) were variously altered, and the results of examining magnetic properties, relative density, permanent flux loss ratio and even dispersion are shown in Chart 4. The mixture amount and the types of NdFeB coarse powder, SmFeN fine powder, and resin used here are the same as in sample No. 1 of the first example embodiment. The production conditions for each bonded magnet are also the same as in the case of the first example embodiment. Also, the measurement method for the bonded magnet comprised of each sample is the same as in the case of the first example embodiment.

(Evaluation)

The following is understood from Chart 5.
1. Samples No. 21 through 24 used a compound obtained by kneading each magnet powder and resin at room temperature. In this case, each powder and resin are only physically mixed, and dispersion of resin in the compound is low. Therefore, relative density is low, and low pressure molding is difficult.

Moreover, it is thought that even in the case of not performing heat kneading, when performing heat molding at the softening point (90° C.) or above, because the NdFeB coarse powder and SmFeN fine powder are coated by surfactant, the SmFeN fine powder strongly adapts in the fluid layer comprised of the melted layer of resin formed during that heat molding, and consequently the ferromagnetic fluid layer stated in the present invention is formed. Due to the appearance of this ferromagnetic fluid layer, high fluidity is conferred during molding of the bonded magnet. It is thought that as a result of the appearance of high filling, high orientation, and deterrence of micro-cracks (deterrence of fractures) in the NdFeB coarse powder in the bonded magnet, a composite rare-earth anisotropic bonded magnet with excellent magnetic properties and corrosion resistance is obtained. In this case, by increasing molding pressure to 882 or 980 MPa, relative density also increases sufficiently, and a bonded magnet with excellent magnetic properties and corrosion resistance is obtained. Also, by making the temperature during magnetic field heat molding greater than the hardening point (150° C.), fluidity due to the above ferromagnetic fluid layer is quickly obtained.
2. Samples No. 25 and 26 used a compound obtained by kneading each magnet powder and resin when heated above the softening point. In this case, even dispersion of SmFeN fine powder in the compound is good. Therefore, sufficient relative density and magnetic properties are obtained even when molding at low pressure, and it is understood to have excellent low pressure molding suitable for mass production of the bonded magnet. Because the fluidity due to the ferromagnetic fluid layer and even dispersion are high, filling factor at the same molding pressure is also increased. As a result, along with improvement in magnetic properties, improvement in corrosion resistance which accompanies the exclusion of oxygen is obtained.

By making the temperature during magnetic field heat molding greater than the hardening point (150° C.), fluidity during that molding increases, and improvements in manufacturability can be expected due to improvements in magnetic properties, permanent flux loss ratio, and also shortened process time.
3. In the case of sample No. H1, magnetic field molding at room temperature is performed, along with room temperature kneading of each magnet powder and resin. Therefore, fluidity of magnet powder in the resin during molding of the bonded magnet, even dispersion in the melted resin and low pressure moldability are poor, and relative density at each molding pressure is lower as well. In this case, even molding at high pressure, only a bonded magnet with low relative density and magnetic properties is obtained.

4. Sample No. H2 was made by heating each magnet powder and resin above the hardening point of thermosetting resin, kneading, and then magnetic field heat molding above that hardening point. When heat kneading above the hardening point, the resin coats the surface of each magnet powder and even dispersion in the compound is good. However, resin hardening continues to advance from this stage forward. Therefore, without the resin sufficiently softening during the subsequent heat molding of the bonded magnet, fluidity of the magnet powder in the resin during molding of the bonded magnet is inferior, and it is not possible to perform sufficient magnetic field orientation, so the magnetic properties of the bonded magnet decrease greatly.

CHART 1

| | | | | | | | | | | | | | | | SmFeN Fine Powder | | | |
|---|---|---|---|---|---|---|---|---|---|---|---|---|---|---|---|---|---|---|
| | | | | | | | | | | | | | | | 10%Sm—77%Fe—13%N | | | |
| | | NdFeB Coarse Powder | | | | | | | | | | | | | (at %) | | | Epoxy |
| | | | | | | | | | | | | | Average | | | Average | | Resin |
| | | | | | | | | | | | | | Grain | Mixture | | Grain | Mixture | Mixture |
| Sample | | Composition (at %) | | | | | | | | | | Sur- | Diameter | Ratio | Sur- | Diameter | Ratio | Ratio |
| No. | | Nd | Dy | B | Fe | Ga | Nb | Zr | Co | La | Pr | factant | (μm) | (%) | factant | (μm) | (%) | (%) |
| Example | 1 | 12.5 | — | 6.4 | Bal. | 0.3 | 0.2 | — | — | — | — | Yes | 106 | 78 | Yes | 3 | 20 | 2 |
| Embodiment | 2 | 12.5 | 0.5 | 6.4 | Bal. | 0.3 | 0.2 | — | — | — | — | Yes | 150 | 76 | Yes | 3 | 22 | 2 |
| | 3 | 12.5 | — | 6.4 | Bal. | 0.3 | 0.2 | — | 3.0 | — | — | Yes | 106 | 75 | Yes | 3 | 23 | 2 |
| | 4 | 13.5 | 0.5 | 6.4 | Bal. | 0.3 | 0.2 | — | — | — | — | Yes | 75 | 77 | Yes | 3 | 21 | 2 |
| | 5 | 12.3 | — | 12.1 | Bal. | 0.3 | 0.2 | — | 3.0 | 0.02 | — | Yes | 80 | 80 | Yes | 2 | 18 | 2 |
| | 6 | 12.5 | 0.7 | 12.0 | Bal. | 0.3 | 0.2 | — | 5.0 | 0.3 | — | Yes | 122 | 80 | Yes | 2 | 18 | 2 |
| | 7 | 12.8 | — | 6.4 | Bal. | 0.3 | 0.2 | — | — | 0.5 | — | Yes | 106 | 75 | Yes | 3 | 23 | 2 |
| | 8 | 12.3 | — | 6.3 | Bal. | 0.3 | 0.2 | — | 6.0 | — | — | Yes | 68 | 75 | Yes | 3 | 22.5 | 1.5 |
| | 9 | 12.6 | — | 6.5 | Bal. | 0.3 | — | 0.1 | 17.4 | — | — | Yes | 125 | 83 | Yes | 3 | 15.5 | 1.5 |
| | 10 | 12.8 | — | 6.0 | Bal. | 0.5 | — | 0.1 | 15.0 | — | — | Yes | 130 | 72 | Yes | 2 | 25.5 | 2.5 |
| | 11 | 12.5 | — | 6.2 | Bal. | — | — | — | — | — | — | Yes | 90 | 62.5 | Yes | 2 | 35 | 2.5 |
| | 12 | 12.0 | — | 6.2 | Bal. | 0.3 | 0.2 | — | — | — | 0.5 | Yes | 88 | 63 | Yes | 2 | 35 | 2 |

CHART 2

| | | | | | | | | | | | | | | | SmFeN Fine Powder | | | |
|---|---|---|---|---|---|---|---|---|---|---|---|---|---|---|---|---|---|---|
| | | | | | | | | | | | | | | | 10%Sm—77%Fe—1%3N | | | |
| | | NdFeB Coarse Powder | | | | | | | | | | | | | (at %) | | | Epoxy |
| | | | | | | | | | | | | | Average | | | Average | | Resin |
| | | | | | | | | | | | | | Grain | Mixture | | Grain | Mixture | Mixture |
| Sample | | Composition (at %) | | | | | | | | | | Sur- | Diameter | Ratio | Sur- | Diameter | Ratio | Ratio |
| No. | | Nd | Dy | B | Fe | Ga | Nb | Zr | Co | La | Pr | factant | (μm) | (%) | factant | (μm) | (%) | (%) |
| Com- | C1 | 12.5 | — | 6.4 | Bal. | 0.3 | 0.2 | — | — | — | — | No | 106 | 78 | Yes | 3 | 20 | 2 |
| parison | C2 | 12.5 | — | 6.4 | Bal. | 0.3 | 0.2 | — | — | — | — | Yes | 106 | 78 | No | 3 | 20 | 2 |
| Exam- | D1 | 13.5 | 0.5 | 6.4 | Bal. | 0.3 | 0.2 | — | — | — | — | Yes | 45 | 78 | Yes | 3 | 20 | 2 |
| ple | D2 | 13.5 | 0.5 | 6.4 | Bal. | 0.3 | 0.2 | — | — | — | — | Yes | 425 | 78 | Yes | 3 | 20 | 2 |
| | E1 | 12.5 | — | 6.4 | Bal. | 0.3 | 0.2 | — | — | — | — | Yes | 106 | 45 | Yes | 3 | 53 | 2 |
| | E2 | 12.5 | — | 6.4 | Bal. | 0.3 | 0.2 | — | — | — | — | Yes | 106 | 88 | Yes | 3 | 10 | 2 |
| | F1 | 13.5 | 0.5 | 6.4 | Bal. | 0.3 | 0.2 | — | — | — | — | Yes | 106 | 86 | Yes | 3 | 12 | 2 |
| | F2 | 13.5 | 0.5 | 6.4 | Bal. | 0.3 | 0.2 | — | — | — | — | Yes | 106 | 53 | Yes | 3 | 45 | 2 |
| | G1 | 12.5 | — | 6.4 | Bal. | 0.3 | 0.2 | — | — | — | — | Yes | 106 | 79.5 | Yes | 3 | 20 | 0.5 |
| | G2 | 12.5 | — | 6.4 | Bal. | 0.3 | 0.2 | — | — | — | — | Yes | 106 | 73 | Yes | 3 | 15 | 12 |

CHART 3

| | | | Relative Density | | Permanent Flux Loss | | Even Dispersion of |
|---|---|---|---|---|---|---|---|
| | | | (%) | | Ratio (%) | | SmFeN Powder on |
| | | Max Energy Product | Molding | Molding | Atmospheric | Atmospheric | Entire Surface of |
| Sample | | (BH)max | Pressure | Pressure | Temperature | Temperature | NdFeB Coarse |
| No. | | (kJ/m³) | 392 MPa | 882 MPa | 100° C. | 120° C. | Powder |
| Example | 1 | 184 | 95 | 97.5 | −4.0 | −6.1 | Yes |
| Embodiment | 2 | 171 | 96 | 97.5 | −3.9 | −5.5 | Yes |
| | 3 | 201 | 94 | 95 | −4.8 | −5.1 | Yes |
| | 4 | 164 | 95 | 96 | −3.3 | −5.0 | Yes |
| | 5 | 145 | 95 | 97 | −3.4 | −4.9 | Yes |
| | 6 | 153 | 96 | 97 | −3.2 | −4.8 | Yes |
| | 7 | 184 | 95 | 97.5 | −3.2 | −4.8 | Yes |
| | 8 | 206 | 96 | 97.5 | −3.4 | −5.2 | Yes |
| | 9 | 168 | 95 | 97 | −3.4 | −5.4 | Yes |
| | 10 | 169 | 94 | 97 | −3.5 | −5.6 | Yes |
| | 11 | 144 | 94 | 96 | −4.5 | −6.5 | Yes |
| | 12 | 185 | 93 | 96 | −4.3 | −6.2 | Yes |

CHART 4

| | | | | | Permanent Flux | Even | |
|---|---|---|---|---|---|---|---|
| | | | | | Loss Ratio | Dispersion | |
| | | | | | (%) | of SmFeN | |
| | | | | | at Atmospheric | Powder on | |
| | | | Relative Density | | Temperature | Entire | |
| | | Max Energy | (%) | | 100° C., | Surface of | |
| Sample | | Product (BH)max | Molding Pressure | Molding Pressure | Molding Pressure | NdFeB Coarse | |
| No. | | (kJ/m3) | 392 MPa | 882 MPa | 882 MPa | Powder | Point of Comparison |
| Comparison | C1 | 180 | 87 | 94 | −6.1 | No | NdFeB magnet powder |
| Example | | | | | | (Not entire | No surfactant |
| | | | | | | surface) | |
| | C2 | 182 | 87 | 94 | −7.0 | No | SmFeN magnet powder |
| | | | | | | (Not even) | No surfactant |
| | D1 | 127 | 94 | 95 | −4.0 | Yes | NdFeB magnet powder |
| | | | | | | | average grain diameter |
| | | | | | | | Below lower limit |
| | D2 | 135 | 95 | 96 | −3.5 | Yes | NdFeB magnet powder |
| | | | | | | | average grain diameter |
| | | | | | | | Above upper limit |
| | E1 | 160 | 94 | 95 | −4.5 | Yes | NdFeB magnet powder |
| | | | | | | | mixture ratio |
| | | | | | | | Below lower limit |
| | E2 | 175 | 90 | 93 | −6.0 | No | NdFeB magnet powder |
| | | | | | | (Not entire | mixture ratio |
| | | | | | | surface) | Above upper limit |
| | F1 | 151 | 89 | 92 | −6.2 | No | SmFeN magnet powder |
| | | | | | | (Not entire | mixture ratio |
| | | | | | | surface) | Below lower limit |
| | F2 | 135 | 93 | 95 | −5.0 | Yes | SmFeN magnet powder |
| | | | | | | | mixture ratio |
| | | | | | | | Above upper limit |
| | G1 | 180 | 92 | 93 | −7.0 | Yes | Resin mixture ratio |
| | | | | | | | Below lower limit |
| | G2 | 130 | 94 | 96 | −3.0 | Yes | Resin mixture ratio |
| | | | | | | | Above upper limit |

CHART 5

| | | | | | | | Permanent Flux | | |
|---|---|---|---|---|---|---|---|---|---|
| | | | | | | | Loss Ratio | | |
| | | Heat | Conditions for Molding in | | Max Energy | | (%) | | |
| | | Kneading | Magnetic Field | | Product | Relative | at Atmospheric | | Molding Pressure: |
| | | Temperature | Temperature | Molding | (BH)max | Density | Temperature | Even | Relative Density |
| Sample No. | | (° C.) | (° C.) | Pressure (MPa) | (kJ/m³) | (%) | 100° C. | Dispersion | at 392 MPa (%) |
| Example | 21 | Room Temp. | 120 | 882 | 164.0 | 94.0 | 4.1 | No | 87.0 |
| Embodiment | 22 | ↑ | ↑ | 980 | 173.0 | 96.0 | 4.4 | No | |
| | 23 | ↑ | 150 | 882 | 165.0 | 94.4 | 4.1 | No | 87.0 |
| | 24 | ↑ | ↑ | 980 | 174.3 | 96.0 | 4.0 | No | |
| | 25 | 120 | 120 | 882 | 184.0 | 97.0 | 3.7 | Yes | 95.0 |
| | 26 | ↑ | 150 | ↑ | 184.0 | 97.5 | 3.7 | Yes | 95.0 |
| Comparison | H 1 | Room Temp. | Room Temp. | 882 | 137.2 | 85.0 | 7.1 | No | 75.0 |
| Example | H 2 | 150 | 150 | ↑ | 133.5 | 93.0 | 4.2 | Yes | 75.0 |

1. A composite rare-earth anisotropic bonded magnet, comprising:
(A) 50 to 84 mass % of R1FeB coarse powder, comprising:
1. R1FeB anisotropic magnet powder with an average grain diameter of 50 to 400 μm, obtained by performing a hydrogenation treatment on an R1FeB alloy having a rare earth element including yttrium (Y) (hereafter, “R1”), iron (Fe), and boron (B) as its main ingredients; and
2. #1 surfactant that coats the surface of the constituent grains of the said R1FeB anisotropic magnet powder; and
(B) 15 to 40 mass % of R2Fe(N, B) fine powder, comprising:
1. R2Fe (N, B) anisotropic magnet powder with an average grain diameter of 1 to 10 μm, having a rare-earth element including Y (hereafter, “R2”), Fe, and nitrogen (N) or B as its main ingredients; and
2. #2 surfactant that coats the surface of the constituent grains of the said R2Fe (N, B) anisotropic magnet powder; and
(C) 1 to 10 mass % of a resin as binder;
this bonded magnet having the special features that maximum energy product (BH)max is 167 to 223 kJ/m³, and permanent flux loss, which indicates the proportion of magnetic flux loss which can be obtained with remagnetizing after the passage of 1000 hours at 100° C., is 6% or less.

2. The composite rare-earth anisotropic bonded magnet recited in claim 1, wherein at least one of the above R1FeB anisotropic magnet powder or above R2Fe(N, B) anisotropic magnet powder includes 0.05 to 5 at % of one or more of the rare-earth elements (hereafter, “R3”) consisting of dysprosium (Dy), terbium (Tb), neodymium (Nd), and praseodymium (Pr), when taking the whole as 100 at %.

3. The composite rare-earth anisotropic bonded magnet recited in claim 1, wherein at least one of the above R1FeB anisotropic magnet powder or above R2Fe(N, B) anisotropic magnet powder includes 0.01 to 1 at % of lanthanum (La), when taking the whole as 100 at %.

4. A composite rare-earth anisotropic bonded magnet production method comprising:
(1) A heat orientation process in which a mixture comprising:
(A) 50 to 84 mass % of R1FeB coarse powder, comprising
R1FeB anisotropic magnet powder with an average grain diameter of 50 to 400 μm, obtained by performing a hydrogenation treatment on an R1FeB alloy having R1, Fe, and B as its main ingredients, the surface of the constituent grains of R1FeB anisotropic magnet powder being coated with a #1 surfactant; and
(B) 15 to 40 mass % of R2Fe(N, B) fine powder, comprising
R2Fe(N, B) anisotropic magnet powder with an average grain diameter of 1 to 10 μm, having R2, Fe, and N or B as its main ingredients, the surface of the constituent grains of R2Fe (N, B) anisotropic magnet powder being coated with a #2 surfactant; and
(C) 1 to 10 mass % of a resin as binder
is heated to a temperature above the softening point of the said resin, and while keeping that resin in a softened state or melted state, an orienting magnetic field is applied so that the R1FeB coarse powder and R2Fe (N, B) fine powder are oriented; and
(2) A molding process in which, after the said heat orientation process, the mixture is heated and press molded;
this production method having the special feature that a composite rare-earth anisotropic bonded magnet is obtained in which the said R2Fe (N, B) fine powder and said resin are evenly filled into the gaps between constituent grains of the said R1FeB coarse powder.

5. The composite rare-earth anisotropic bonded magnet production method recited in claim 4, wherein the said mixture is comprised of a compound in which the surface of the constituent grains of the said R1FeB coarse powder is coated by a coating layer in which the said R2Fe (N, B) fine powder is evenly dispersed in the said resin.

6. The composite rare-earth anisotropic bonded magnet compound production method recited in claim 5, wherein the above compound is obtained after a heat kneading process in which the above R1FeB coarse powder, above R2Fe(N, B) fine powder, and above resin are heat kneaded at a temperature above the softening point of the said resin.

7. The composite rare-earth anisotropic bonded magnet production method recited in claim 5, wherein the above mixture is comprised of a preparative compact in which the said compound is filled into the cavity of the molding die and then press molded.

8. The composite rare-earth anisotropic bonded magnet production method recited in claim 4, wherein the above resin is thermosetting resin, and the above heat orientation process is performed heating at a temperature above the hardening point of the said thermosetting resin.

9. A composite rare-earth anisotropic bonded magnet compound comprising:
(A) 50 to 84 mass % of R1FeB coarse powder, comprising:
1. R1FeB anisotropic magnet powder with an average grain diameter of 50 to 400 μm, obtained by performing a hydrogenation treatment on an R1FeB alloy having R1, Fe, and B as its main ingredients; and
2. #1 surfactant that coats the surface of the constituent grains of the said R1FeB anisotropic magnet powder; and
(B) 15 to 40 mass % of R2Fe(N, B) fine powder, comprising:
1. R2Fe (N, B) anisotropic magnet powder with an average grain diameter of 1 to 10 μm, having R2, Fe, and N or B as its main ingredients; and
2. #2 surfactant that coats the surface of the constituent grains of the said R2Fe(N, B) anisotropic magnet powder; and
(C) 1 to 10 mass % of a resin as binder;
this bonded magnet compound having the special feature that the surface of the constituent grains of the above R1FeB coarse powder is coated by a coating layer in which the above R2Fe(N, B) fine powder is evenly dispersed in the above resin.

10. The composite rare-earth anisotropic bonded magnet compound recited in claim 9, wherein the relative density of the bonded magnet obtained when performing magnetic field heat molding under conditions of molding temperature 150° C., magnetic field 2.0 MA/m, molding pressure 392 MPa is 92 to 99%.

11. The composite rare-earth anisotropic bonded magnet compound recited in claim 9, wherein at least one of the above R1FeB anisotropic magnet powder or above R2Fe (N, B) anisotropic magnet powder includes 0.05 to 5 at % of one or more of the rare-earth elements (R3) consisting of Dy, Tb, Nd, and Pr, when taking the whole as 100 at %.

12. The composite rare-earth anisotropic bonded magnet recited in claim 9, wherein at least one of the above R1FeB anisotropic magnet powder or above R2Fe(N, B) anisotropic magnet powder includes 0.01 to 1 at % of lanthanum (La), when taking the whole of each as 100 at %.

13. A composite rare-earth anisotropic bonded magnet compound production method comprising:
(1) A mixing process which mixes:
(A) 50 to 84 mass % of R1FeB coarse powder, comprising
R1FeB anisotropic magnet powder with an average grain diameter of 50 to 400 μm, obtained by performing a hydrogenation treatment on an R1FeB alloy having R1, Fe, and B as its main ingredients, the surface of the constituent grains of R1FeB anisotropic magnet powder being coated with a #1 surfactant; and
(B) 15 to 40 mass % of R2Fe(N, B) fine powder, comprising
R2Fe(N, B) anisotropic magnet powder with an average grain diameter of 1 to 10 μm, having R2, Fe, and N or B as its main ingredients, the surface of the constituent grains of R2Fe (N, B) anisotropic magnet powder being coated with a #2 surfactant; and
(C) 1 to 10 mass % of a resin as binder; and
(2) A heat kneading process in which, the mixture obtained after the said mixing process is heat kneaded at a temperature above the softening point of the said resin;
this production method having the special feature that it obtains a compound in which the surface of the constituent grains of the above R1FeB coarse powder is coated by a coating layer in which the above R2Fe(N, B) fine powder is evenly dispersed in the above resin.

14. A composite rare-earth anisotropic bonded magnet with the special feature that it is obtained by the composite rare-earth anisotropic bonded magnet production method recited in any of claims 4 through 8.

15. A composite rare-earth anisotropic bonded magnet compound with the special feature that it is obtained by the composite rare-earth anisotropic bonded magnet compound production method recited in claims 13.
